(19) United States
(12) Patent Application Publication
(10) Pub. No.: US 2017/0206598 A1
(43) Pub. Date: Jul. 20, 2017

(54) SYSTEM AND METHOD FOR PROMPTING TO SUPPORT USER MODIFICATION

(71) Applicant: Goldman, Sachs & Co., New York, NY (US)

(72) Inventors: Anthony Edward Bunnell, Austin, TX (US); David Campos Cardona, Austin, TX (US); William Walter Hurley, Austin, TX (US); Raymond John Kaminski, Austin, TX (US)

(21) Appl. No.: 15/474,682

(22) Filed: Mar. 30, 2017

Related U.S. Application Data
(62) Division of application No. 15/224,194, filed on Jul. 29, 2016.
(60) Provisional application No. 62/198,561, filed on Jul. 29, 2015.

(51) Int. Cl. G06Q 40/02; G06Q 20/40; G06Q 20/10

(52) U.S. Cl. CPC G06Q 40/02; G06Q 20/108; G06Q 20/405; H04W 4/14

(57) ABSTRACT

A method for prompting a user includes determining a threshold value for a defined time period and determining if the user has received funds in excess of the threshold value within the time period. The method also include, in response to determining that the user has received the funds in excess of the threshold value within the time period, prompting the user to deposit at least part of the funds in excess of the threshold value into an account. The method may further include receiving transaction information from the account or another account associated with the user. Determining the threshold value may include creating a statistical model of total transaction value for a time period analogous with the defined time period based on historical transaction information and selecting a value within norms of the statistical model as the threshold value.

### CROSS-REFERENCE TO RELATED APPLICATION AND PRIORITY CLAIM

This application is a divisional of U.S. patent application Ser. No. 15/224,194 filed on Jul. 29, 2016, which claims priority under 35 U.S.C. §119(e) to U.S. Provisional Patent Application No. 62/198,561 filed on Jul. 29, 2015. Both of these applications are hereby incorporated by reference in their entirety.

### TECHNICAL FIELD

This disclosure is generally directed to systems and methods for managing and growing a user's wealth. More specifically, this disclosure relates to systems and methods for financial planning, including systems and methods for the transfer and display of information related to financial accounts, the identification of financial trends, and the allocation and transfer of money between financial accounts.

### BACKGROUND

The allocation of an individual's wealth to financial accounts designed to grow his or her long-term wealth is important. Too many people improperly or inadequately plan for their financial well-being, especially early in their financial lives. Such failure may be mitigated through the use of systems and methods designed to educate, inform, and motivate the individual to act in his or her own financial interests in order to meet his or her desired financial goals. However, many conventional systems and methods are inadequate in one or more respects.

### SUMMARY

This disclosure relates to systems and methods for financial planning.

In a first embodiment, a method for receiving information via a short message service (SMS) type interface includes determining an input variable and generating an SMS-type prompt including a query for an input of a value corresponding to the input variable. The method also includes transmitting the generated SMS-type prompt to a remote device, receiving a value responsive to the requested input variable, and storing the received value in a memory.

In a second embodiment, a method for automatically allocating funds between financial systems includes receiving a weighting preference between multiple variables. The method also includes determining an allocation scheme according to the weighting preference and receiving funds. The method further includes apportioning the received funds between multiple financial transactions associated with the variables according to allocation scheme. In addition, the method includes requesting distribution of the received funds between the financial transactions in accordance with the apportioning.

In a third embodiment, a method of prompting a user includes receiving transaction information from an account associated with the user. The method also includes determining a financial situation that may motivate the user to take a financial action. The method further includes, in response to determining the financial situation, presenting to the user a prompt displaying a tangible item having an associated monetary value, where the tangible item is associated with a transaction in which the user has engaged. In addition, the method includes suggesting the user take the financial action related to the tangible item.

In a fourth embodiment, a method for prompting a user includes determining a threshold value for a defined time period. The method also includes determining if the user has received funds in excess of the threshold value within the time period. The method further includes, in response to determining that the user has received the funds in excess of the threshold value within the time period, prompting the user to deposit at least part of the funds in excess of the threshold value into an account.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates an example computing system that may be utilized in accordance with this disclosure;

FIG. 2 illustrates an example wireless electronic device that may correspond to a client device in accordance with this disclosure;

FIG. 3 illustrates an example distributed system in accordance with this disclosure;

FIG. 4 illustrates an example process flow for receiving financial transaction information initiated by a request from a system server in accordance with this disclosure;

FIG. 5 illustrates an example process flow for receiving financial transaction information pushed to a system server by a financial institution in accordance with this disclosure;

FIG. 6 illustrates an example process flow for transferring funds within a system server based on user preferences in accordance with this disclosure;

FIG. 7 illustrates an example process flow for transferring funds based on user preferences when funds are located in a financial institution in accordance with this disclosure;

FIG. 8 illustrates an example information flow for providing and receiving user account information to a server in accordance with this disclosure;

FIG. 9 illustrates an example process flow for receiving and outputting modifiable input variables in accordance with this disclosure;

FIG. 10 illustrates an example method of structuring a hierarchical constraining loop for modifiable input and output fields in accordance with this disclosure;

FIG. 11 illustrates an example process flow for obtaining user inputs via a conversational-style interface using SMS-type context cards in accordance with this disclosure;

FIG. 12 illustrates an example string of SMS-type context cards in accordance with this disclosure;

FIG. 13 illustrates an example process flow for creating a weighting tool and receiving a weighting preference in accordance with this disclosure;

FIG. 14 illustrates an example visual field and selection point corresponding to a weighting tool having three variables in accordance with this disclosure;

FIG. 15 illustrates an example process flow for determining a user weighting preference between four variables in accordance with this disclosure;

FIG. 16 illustrates an example series of visual fields depicting different stages of modification of a z-axis coordinate for a three-dimensional weighting tool in accordance with this disclosure;

FIG. 17 illustrates an example process flow for distributing/allocating funds according to weighted user preferences in accordance with this disclosure;

FIG. 18 illustrates an example process flow for the sub-distribution/allocation of funds according to weighted user sub-preferences according to a cascading weighting system and method in accordance with this disclosure;

FIG. 19 illustrates an example process flow for suggesting modification of user behavior in relation to disposable income spending habits in accordance with this disclosure;

FIG. 20 illustrates an example process flow for determining whether a transaction is related to disposable income in accordance with this disclosure;

FIG. 21 illustrates an example process flow for determining the relatedness of vendors based on transaction information in accordance with this disclosure;

FIG. 22 illustrates an example process flow for a financial trend discovery engine in accordance with this disclosure;

FIG. 23 illustrates an example process flow for generating a user prompt directed at educating a user as to financial impact of his or her spending decisions and curbing negative spending habits in accordance with this disclosure;

FIG. 24 illustrates an example user prompt directed at educating a user as to financial impact of his or her spending decisions and curbing negative spending habits in accordance with this disclosure;

FIG. 25 illustrates an example process flow for generating a user prompt directed at providing a user an opportunity to change a spending decision and curbing a negative spending habit in relation to providing an opportunity to make a contribution of an amount determined in relation to a profile preference for the user in accordance with this disclosure;

FIG. 26 illustrates an example process flow for providing a user the opportunity to make contributions to a financial account based on representative tangible items in accordance with this disclosure;

FIG. 27 illustrates an example process flow for determining whether a transaction is above a threshold value related to a vendor type in accordance with this disclosure;

FIG. 28 illustrates an example process flow for generating a listing of tangible items and their associated values for presentation to a user in accordance with this disclosure;

FIG. 29 illustrates an example process flow for generating a user prompt requesting contribution to a financial account based on tangible items in accordance with this disclosure;

FIG. 30 illustrates an example control loop for updating values associated with tangible items in accordance with this disclosure;

FIG. 31 illustrates an example control loop for updating threshold values for transactions related to specific vendor types in accordance with this disclosure;

FIG. 32 illustrates an example control loop for updating blackout periods for limiting the frequency of generating user prompts in accordance with this disclosure;

FIG. 33 illustrates an example process flow for determining fund allocation preferences for transaction values in relation to thresholds in accordance with this disclosure;

FIG. 34 illustrates another example process flow for determining fund allocation preferences for transaction values in relation to thresholds in accordance with this disclosure;

FIG. 35 illustrates an example process flow for determining fund allocation preferences for transaction values exceeding thresholds when account information is not provided in accordance with this disclosure;

FIG. 36 illustrates an example process flow for determining fund allocation preferences for transaction values in relation to a profile in accordance with this disclosure;

FIG. 37 illustrates an example process flow for determining fund allocation preferences for transaction values in relation to a profile and a user query in accordance with this disclosure; and

FIG. 38 illustrates an example process flow for identifying changes in a user's financial circumstances and prompting a change in distribution/allocation preferences related thereto in accordance with this disclosure.

### DETAILED DESCRIPTION

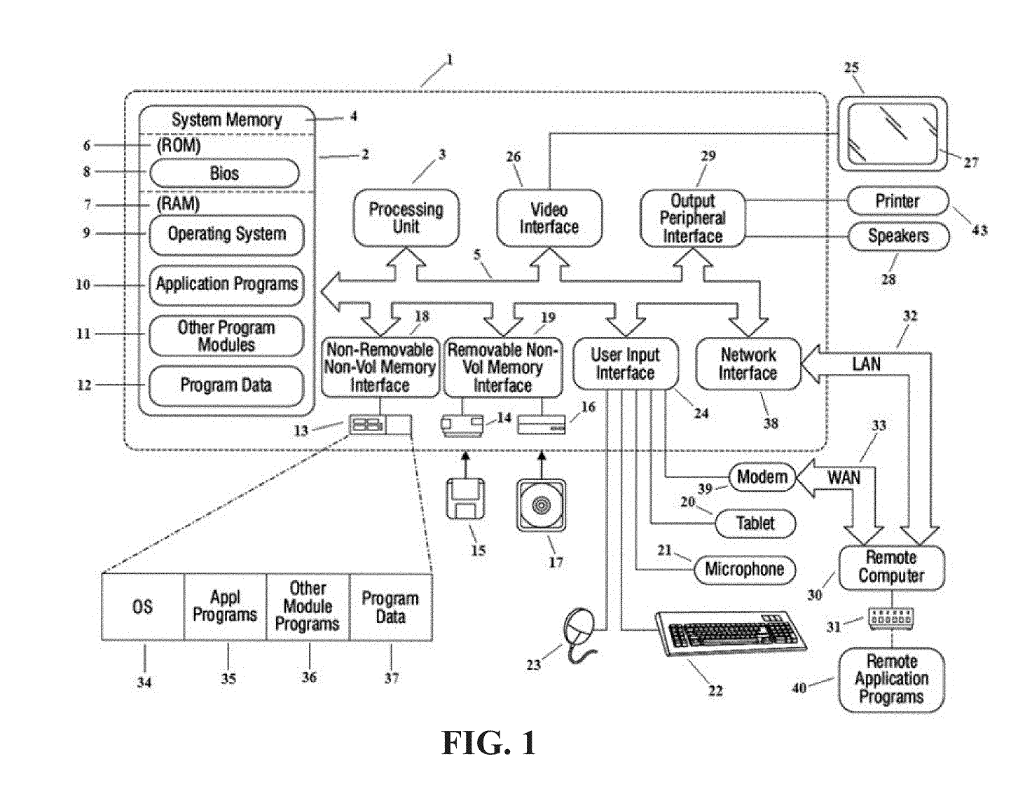

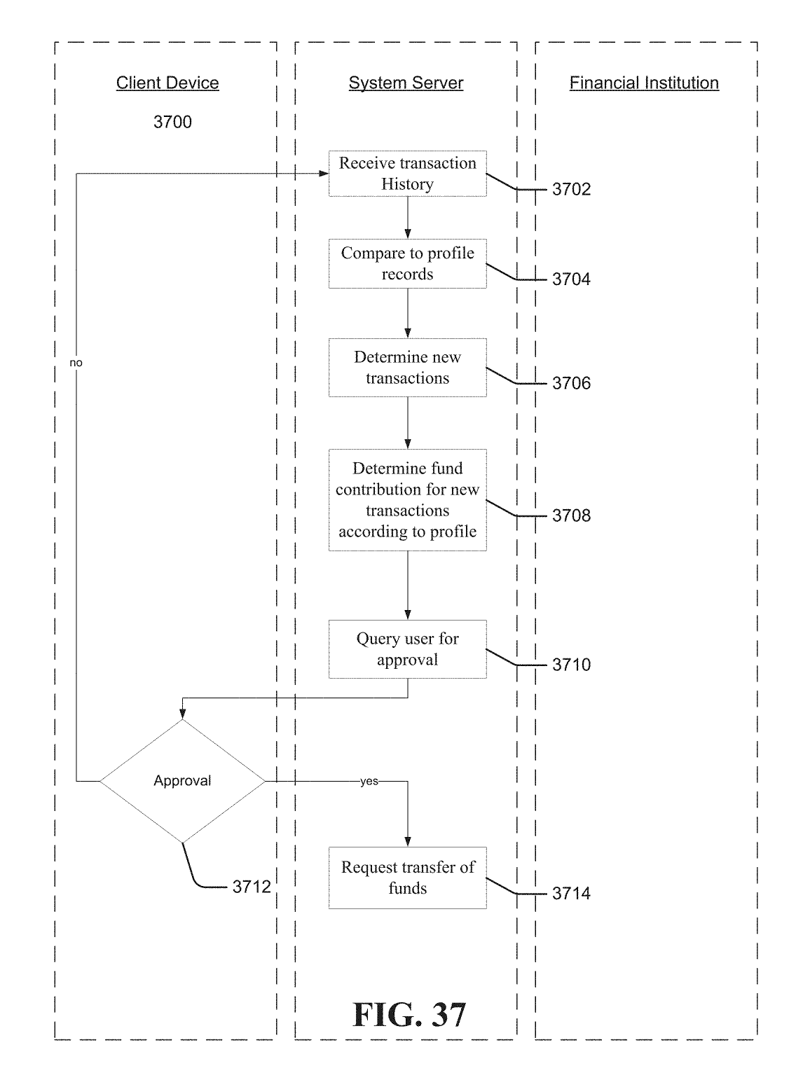

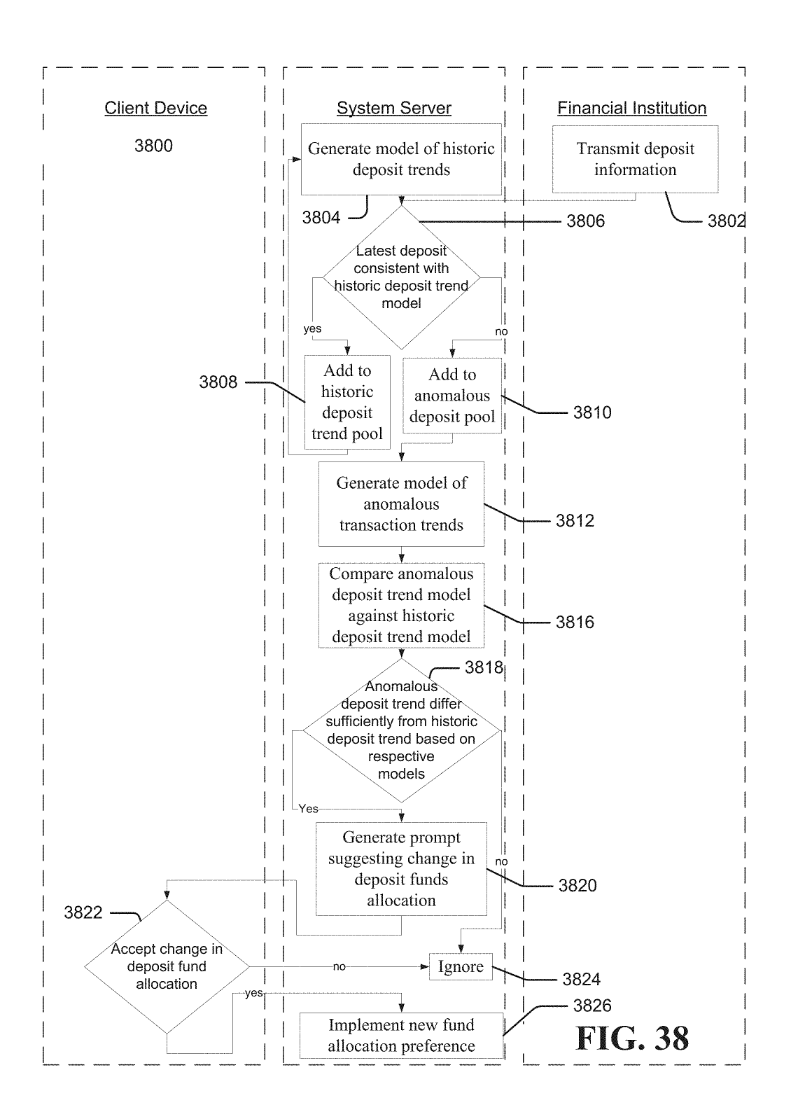

FIGS. 1 through 38, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

Unless otherwise defined, all terms (including technical and scientific terms) used in this patent document have the same meaning as commonly understood by one of ordinary skill in the art to which this disclosure belongs. It will also be understood that terms, such as those defined in commonly-used dictionaries, should be interpreted as having meanings that are consistent with their meaning in the context of the relevant art and the present disclosure and will not be interpreted in an idealized or overly formal sense unless expressly so defined in this patent document.

Descriptions of certain illustrative aspects are described below in connection with the figures. These aspects are indicative of various non-limiting ways in which the disclosed subject matter may be utilized, all of which are intended to be within the scope of the disclosed subject matter. Other advantages, emerging properties, and features will become apparent from the following description when considered in conjunction with the associated figures that are also within the scope of the disclosure.

Although described with reference to personal computers and the Internet, one skilled in the art could apply the principles discussed here to any computing or mobile computing environment. Further, one skilled in the art could apply the principles discussed here to communication mediums beyond the Internet.

It will be appreciated that, for simplicity and clarity of illustration, reference numerals may be repeated among the figures to indicate corresponding or analogous elements where considered appropriate. In addition, numerous specific details are set forth below in order to provide a thorough understanding of the implementations described here. However, it will be understood by those of ordinary skill in the art that the implementations described here may be practiced without these specific details. In other instances, well-known methods, procedures, and components have not been described in detail so as not to obscure the implementations described here. Also, the description is not to be considered as limiting the scope of the implementations described here.

In the following description, reference is made to the accompanying drawings, which show by way of illustration specific implementations that may be practiced. These implementations are described in sufficient detail to enable those skilled in the art to practice the implementations, and it is to be understood that other implementations may be utilized and that logical, mechanical, electrical, and other changes may be made without departing from the scope of the implementations. The following description is therefore not to be taken in a limiting sense.

FIG. 1 illustrates an example computing system 1 that may be utilized in accordance with this disclosure. The computing system 1 can be used to implement the systems and methods described in this disclosure. In some embodiments, the computing system 1 may include a computing device commercially available from, for example, INTEL, IBM, AMD, APPLE, MOTOROLA, or CYRIX. Components of the computing system 1 may include, but are not limited to, at least one memory 2 and at least one processing unit 3. The at least one memory 2 includes a system memory 4. At least one system bus 5 couples various system components including the system memory 4 to the processing unit 3. The system bus 5 may be any of several types of bus structures, including a memory bus or memory controller, a peripheral bus, or a local bus using any of a variety of bus architectures.

The computing system 1 may include a variety of computer-readable media. The computer readable media can be any available media that can be accessed by the computing system 1 and include both volatile and nonvolatile media and both removable and non-removable media. By way of example, computer readable media may include computer storage media. Computer storage media include volatile and nonvolatile, removable and non-removable media implemented in any method or technology for storage of information such as computer readable instructions, data structures, program modules or other data. Computer memory may include, but is not limited to, random access memory (RAM), read only memory (ROM), erasable programmable read only memory (EPROM), electrically erasable programmable read only memory (EEPROM), Flash memory, or other memory technology; compact disc (CD), digital versatile disc (DVD), or other optical disk storage; magnetic cassettes, magnetic tape, magnetic disk storage or other magnetic storage devices; or any other medium that can be used to store desired information and that can be accessed by the computing system 1.

The system memory 4 may include computer storage media in the form of volatile and/or nonvolatile memory, such as ROM 6 and RAM 7. A basic input/output system (BIOS) 8 containing the basic routines that help to transfer information between elements within the computing system 1, such as during start-up, is typically stored in ROM 6. RAM 7 typically contains data and/or program modules that are immediately accessible to and/or presently being operated on by the processing unit 3. By way of example and not limitation, an operating system 9, application programs 10, other program modules 11, and program data 12 are shown.

The computing system 1 may also include other removable/non-removable, volatile/nonvolatile computer storage media. By way of example only, a hard disk drive 13 that reads from or writes to non-removable nonvolatile magnetic media, a magnetic disk drive 14 that reads from or writes to a removable nonvolatile magnetic disk 15, and an optical disk drive 16 that reads from or writes to a removable nonvolatile optical disk 17 (such as a CD-ROM or other optical media) could be employed to store information (including data or instructions implementing the systems and methods described in this patent document). Other removable/non-removable, volatile/nonvolatile computer storage media that can be used in the example operating environment include but are not limited to magnetic tape cassettes, Flash memory cards, DVDs, digital video tapes, solid-state RAM, solid-state ROM, and the like. The hard disk drive 13 is typically connected to the system bus 5 through a non-removable memory interface such as interface 18, and the magnetic disk drive 14 and the optical disk drive 16 are typically connected to the system bus 5 by a removable memory interface, such as interface 19.

The drives and their associated computer storage media, discussed above, provide storage of computer readable instructions, data structures, program modules, and other data for the computing system 1. For example, the hard disk drive 13 is illustrated as storing an operating system 34, application programs 35, other program modules 36, and program data 37. Note that these components can either be the same as or different from the operating system 9, application programs 10, other program modules 11, and program data 12. The operating system 34, application programs 35, other program modules 36, and program data 37 are given different numbers here to illustrate that, at a minimum, they are different copies.

A user may enter commands and information into the computing system 1 through input devices such as a tablet or electronic digitizer 20, a microphone 21, a keyboard 22, and a pointing device 23 (such as a mouse, trackball, or touchpad). These and other input devices are often connected to the processing unit 3 through a user input interface 24 that is coupled to the system bus 5, but they may be connected by other interfaces and bus structures, such as a parallel port, game port, or universal serial bus (USB).

A monitor 25 or other type of display device is also connected to the system bus 5 via an interface, such as a video interface 26. The monitor 25 may also be integrated with a touch-screen panel 27 or the like. Note that the monitor and/or touch screen panel can be physically coupled to a housing in which the computing system 1 is incorporated, such as in a tablet-type personal computer or smartphone. In addition, computers such as the computing system 1 may also include other peripheral output devices, such as speakers 28 and a printer 43, which may be connected through an output peripheral interface 29 or the like.

The computing system 1 may operate in a networked environment using logical connections to one or more remote computers, such as a remote computing system 30. The remote computing system 30 may be a personal computer (including but not limited to mobile electronic devices), a server, a router, a network personal computer, a peer device, or other common network node and typically includes many or all of the elements described above relative to the computing system 1 (although only a memory storage device 31 has been illustrated). The logical connections depicted include a local area network (LAN) 32 connecting through network interface 38 and a wide area network (WAN) 33 connecting via modem 39, but they may also include other networks such as mobile telephone service networks. Such networking environments are commonplace in offices, enterprise-wide computer networks, intranets, mobile networks, and the Internet.

In some embodiments, the computer system 1 may include a source machine from which data is being generated/transmitted, and the remote computing system 30 may include a destination machine. In other embodiments, the remote computing system 30 may include the source machine from which data is being generated/transmitted, and the computer system 1 may include the destination machine. In still other embodiments, the computing system 1 may include both a source machine from which data is being generated/transmitted and a destination machine, and the remote computing system 30 may also include both a source machine from which data is being generated/transmitted and a destination machine. Note, however, that source and destination machines need not be connected by a network or any other means, and data may be transferred via any media capable of being written by the source platform and read by the destination platform or platforms.

For the purposes of this disclosure, it will be appreciated that the remote computing system 30 may be referred to in various ways, such as but not limited to ‘device,’ ‘processor-based mobile device,’ ‘mobile device,’ ‘electronic device,’ ‘processor-based mobile electronic device,’ ‘mobile electronic device,’ ‘wireless electronic device,’ or ‘location-capable wireless device.’ In particular embodiments, the remote computing system 30 includes a smartphone or tablet computer.

The processing unit 3 in the computing system 1 or the remote computing system 30 may operate pursuant to operating system software, such as but not limited to APPLE IOS, GOOGLE ANDROID, IBM OS/2, LINUX, UNIX, MICROSOFT WINDOWS, APPLE MAC OS X, or other commercially-available operating systems that provide functionality for the services provided by the present disclosure. The operating system or systems may reside at a central location or distributed locations (i.e., mirrored or standalone).

Software programs or modules instruct the operating systems to perform tasks such as but not limited to facilitating client requests, system maintenance, security, data storage, data backup, data mining, document/report generation, and algorithm generation. The provided functionality may be embodied directly in hardware or in one or more software or firmware programs or modules executed by at least one processor. A software module (program or executable) may reside in RAM, ROM, EPROM, EEPROM, Flash memory, registers, hard disk, removable disc, CD, DVD, optical disk, or any other form of storage medium known or developed in the art. An example storage medium is coupled to the processor such that the processor can read information from and/or write information to the storage medium. The storage medium may also be integral to the processor. The processor and the storage medium may also reside in an application specific integrated circuit (ASIC) or other circuit. The bus may be an optical or conventional bus operating pursuant to various protocols that are well-known or developed in the art.

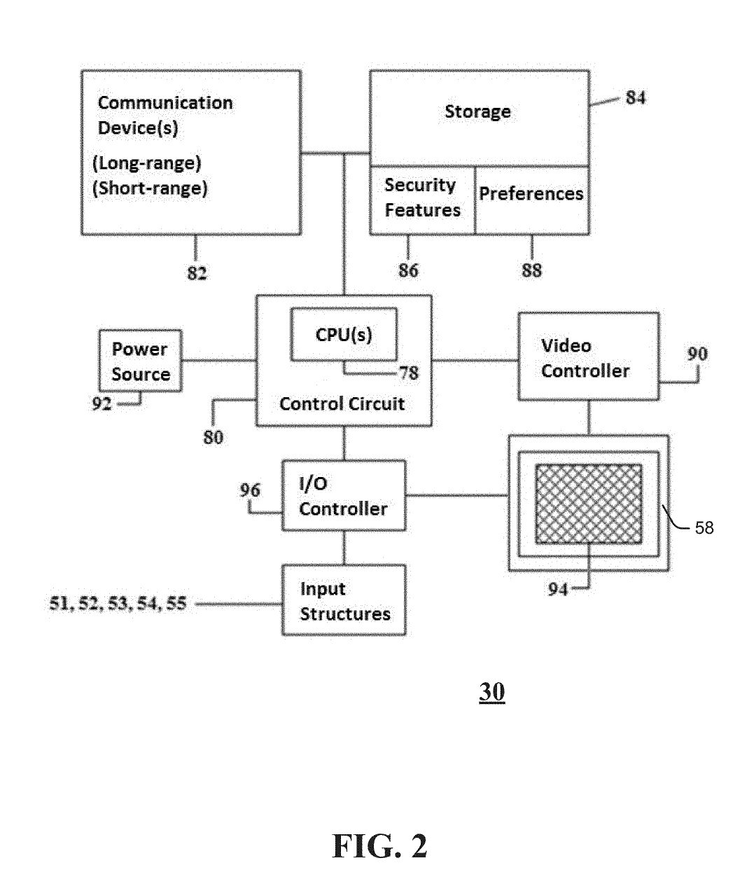

FIG. 2 illustrates an example wireless electronic device that may correspond to a client device (such as the remote computing system 30) in accordance with this disclosure. Without limitation, it will be understood that the electronic device 30 may be, for example, a smartphone, wireless tablet, or other suitable wireless smart device. The electronic device 30 may include a display 58, a central processing unit (CPU) 78, a touch screen interface 94, an input/output (I/O) controller 96, a storage device 84, one or more communication devices 82, a video controller 90, control circuitry 80, and a power source 92.

The CPU 78 and the control circuit 80 may control the operation of the electronic device 30. In conjunction, these elements may provide the processing capability required to execute an operating system, application programs (‘apps’), a graphical user interface (GUI), and any other functions provided on the electronic device 30. The control circuit 80 may include one or more data buses for transferring data and instructions between components of the device 30. The control circuit 80 may also include on board memory (such as RAM) for caching purposes.

The CPU 78 may include one or more processors. For example, the CPU 78 may include ‘general purpose’ microprocessors, a combination of general and application-specific microprocessors, instruction set processors, graphics processors, or video processors, as well as related chips sets and/or special-purpose microprocessors. The electronic device 30 may also include a standalone RAM (not shown) in communication with the CPU 78 by way of one or more memory controllers (not shown), which may be integrated within the control circuit 80.

The CPU 78 may use information that can be stored within a long-term storage device, such as the storage device 84. The storage device 84 may be utilized for storing data required for the operation of the CPU 78, data to be processed or executed by the CPU 78, and other data required by the electronic device 30 (such as application and program data). For example, the storage device 84 may be configured to store the firmware for the electronic device 30 that is used by the CPU 78. The firmware may include an operating system or systems, as well as other programs or drivers that enable various functions of the electronic device 30, GUI functions, and/or processor functions. The storage device 84 may also store components for a GUI, such as graphical elements, screens, and templates. The storage device 84 may further store data files such as media (e.g., music and video files), image data, application software, preference information (e.g., media playback preferences, general user preferences), network connection information (e.g., information that may enable the electronic device 30 to establish a wireless connection, such as a telephone or Internet connection), subscription information (e.g., information that maintains a record of television shows or other media to which a user subscribes), telephone information (e.g., telephone numbers), and any other suitable data required by the electronic device 30. The storage 84 may be non-volatile memory, such as ROM, Flash, or solid-state memory, a hard disk drive, or any other suitable optical, magnetic, solid-state, or other computer readable media, as well as a combination thereof.

The communication devices 82 provide additional connectivity channels for receiving and transmitting information. For example, the communication devices 82 may represent a network controller as well as various associated communication protocols. The communication devices 82 may provide for various long-range communication interfaces, such as a wireless local area network (WLAN) interface (e.g., an IEEE 802.11x wireless network), a LAN interface, or a WAN interface. For example, a WAN interface may permit a private and/or secure connection to a cellular data network, such as 3G, 4G, and LTE networks. The communication devices 82 may also provide a short message service (SMS) interface or other message-based interface. The communication devices 82 may further provide for short-range communication interfaces, such as a personal area network (PAN) interface. The PAN interface may provide capabilities to network with, for example, a BLUETOOTH network or an ultra-wideband (UWB) network. The communication devices 82 may include any number and combination of network interfaces. As will be acknowledged, the communication devices 82 may employ one or more protocols, such as the High-Speed Downlink Packet Access (HSDPA) protocol, for rapidly downloading data over a network. The communication devices 82 may additionally allow the electronic device 30 to receive software upgrades.

The electronic device 30 may further include a service discovery networking protocol to establish a connection with an external device through a network interface in specific embodiments. For example, both the electronic device 30 and the external device may broadcast identification information using Internet Protocol (IP) or other standards. The external device may additionally broadcast information relating to available services that the external device is capable of providing (e.g., printing services for a networked printer). The devices may then use the identification information to establish a network connection between the devices.

Properties of the above-mentioned communication devices 82 may be determined by user preference settings 88. The user preference settings 88 may be stored in the storage device 84. For instance, the user preference settings 88 may include a list of networks that the electronic device 30 may connect to and may further govern the order or priority between the communication interfaces.

The communication preferences associated with the user preference settings 88 may also be dependent upon security features 86 available for each respective communication device 82. The security features 86 may be stored in the storage device 84 and may include one or more cryptographic protocols, such as a secure sockets layer (SSL) protocol or a transport layer security (TLS) protocol, for establishing secure communications between the electronic device 30 and an external device. The security features 86 may also include one or more encryption applications for encrypting information sent from the electronic device 30. These features may be particularly useful when transmitting information of a sensitive nature, which may generally include credit card and bank account information.

To limit access to the sensitive data, such as encryption keys, passcodes and passwords, authentication keys, digital certificates, or the like, the security features 86 may also include a secure access-restricted storage area (e.g., within the storage device 84). Additionally, in some embodiments, the secure storage area, in addition to storing the above-mentioned sensitive data, may be further protected by its own respective password, personal identification number (PIN), or another personal identification method, such as ‘touch ID’ or biometric identification, in order to prevent unauthorized access to the information stored therein.

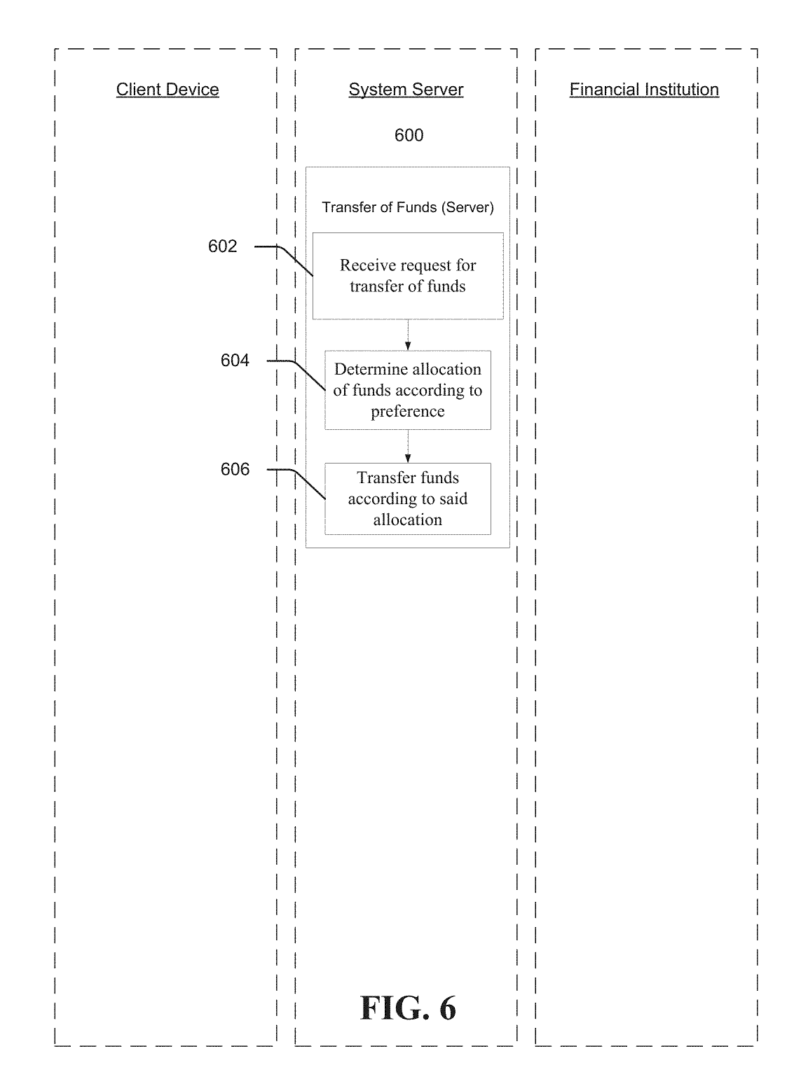

The video controller 90 may be operatively coupled to the display 58 and configured to receive image data and to send voltage signals corresponding to the pixel values of the image data to the display 58. The displayed image data may represent information received through the communication devices 82, as well as information contained in the storage device 84. As will be understood by those skilled in the art, pixel values may be numerical assignments corresponding to respective pixel intensities. Therefore, the display 58 may receive the voltage signals from the video controller 90 as an input and produce an image corresponding to the voltage signals. With reference to FIGS. 6, 9, 14, and 17, an image produced by the signals provided by the video controller 90 may represent a screen of a GUI.

A user may select various graphical elements, which can represent applications or information, that may be displayed through the GUI. The touch screen interface 94 may be positioned in front of or behind the display 58 and may provide a user with the ability to select graphical elements, such as icons displayed by the GUI. The touch screen interface 94 may be configured to receive inputs based on physical contact (e.g., touching the display 58 when engaging an icon) either by the user or an object (e.g., stylus) being controlled or manipulated by the user, and to send ‘touch event’ information to the CPU 78. The CPU 78 may then process the detected touch event information and perform a corresponding action. For example, the ‘touching’ of an icon may be processed by the CPU 78 as an instruction to execute or initiate the corresponding application. The touch screen interface 94 may employ any suitable type of touchscreen technology, such as resistive, capacitive, infrared, surface acoustic wave, electromagnetic, or near field imaging. The touch screen interface 94 may further include single-point or multipoint sensing. It will be understood that the electronic device 30 may include a touch screen controller (not shown) in communication with the touch screen interface 94.

A user may communicate with the CPU 78 through various input structures utilizing the infrastructure provided by the I/O controller 96. The input structures provided on the electronic device 30 include input complexes represented by reference numerals 51-55. The user input structures may be used in conjunction with or independently of the touch screen interface 94 to provide input information to the electronic device 30.

The electronic device 30 may be powered by the power source 92 in both non-portable and portable settings. In a portable setting, for instance, in order to facilitate transport and ease of motion, the electronic device 30 may include an integrated power source 92 for powering the electronic device 30. The power source 92 may include one or more batteries, such as one or more lithium-ion batteries, which may be user-removable or secured to the electronic device 30. In specific embodiments, a proprietary connection I/O port may be used to connect the electronic device 30 to a power source in order to recharge the battery. In other embodiments, the one or more batteries may be non-integrated and may include one or more rechargeable or replaceable batteries. Further, in a non-portable setting, the power source 92 may include alternating current (AC) power, such as is provided by an electrical outlet.

Depicted screen images may be generated by a GUI and displayed on the display 58. For instance, these screen images may be generated as a user interacts with the electronic device 30, such as via the input structures and/or the touch screen interface 94. The GUI, depending on the inputs and selections made by a user, may display various screens including icons and graphical elements. These elements may represent graphical and virtual elements or ‘buttons’ that may be selected by the user by physically touching their respective locations on the display 58 using the touch screen interface 94, for example. The functionalities set forth and described in the subsequent figures may be achieved using a wide variety of graphical elements and visual schemes. Thus, it should also be understood that the present disclosure is not intended to be limited to the precise user interface conventions depicted here. Embodiments of this disclosure may include a wide variety of GUI styles.

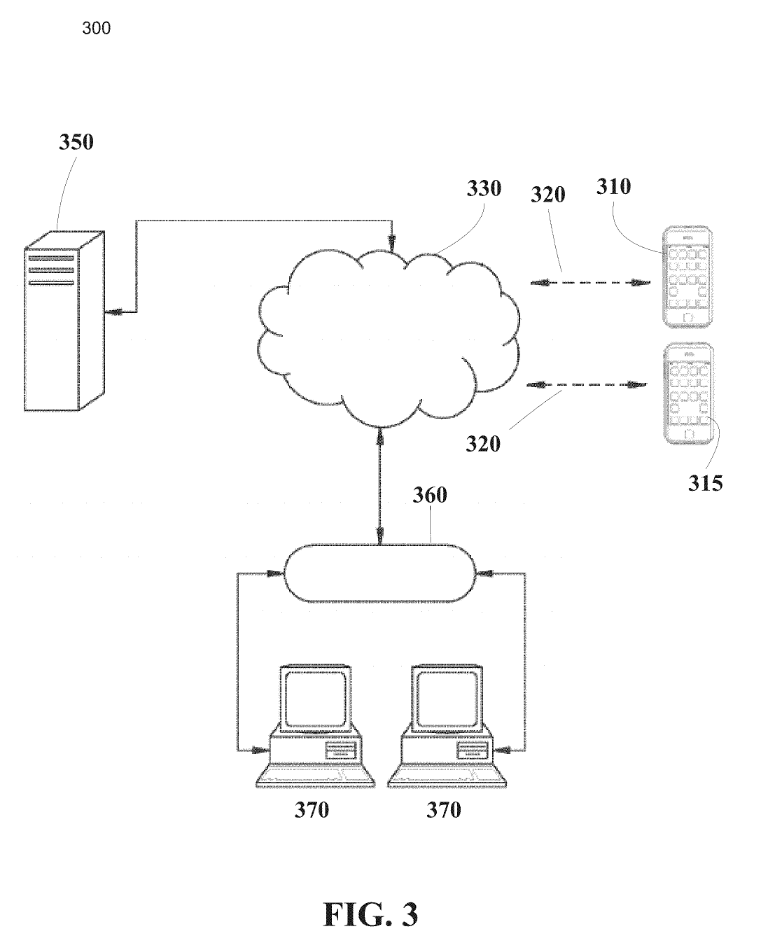

FIG. 3 illustrates an example distributed system 300 in accordance with this disclosure. In this example, the system 300 includes one or more wireless electronic device 310 and 315, which could be similar or identical to the wireless electronic device 30 illustrated in FIG. 2. The system 300 also includes a server 350, data communications infrastructure such as the Internet 330, a network 360, and one or more computing systems 370. Wireless communications infrastructure, such as a wireless communications network 320, provides wireless connectivity for the electronic devices 310 and 315. Wired or wireless connections may also provide a network interface or connection for connecting the server 350 to the Internet 330.

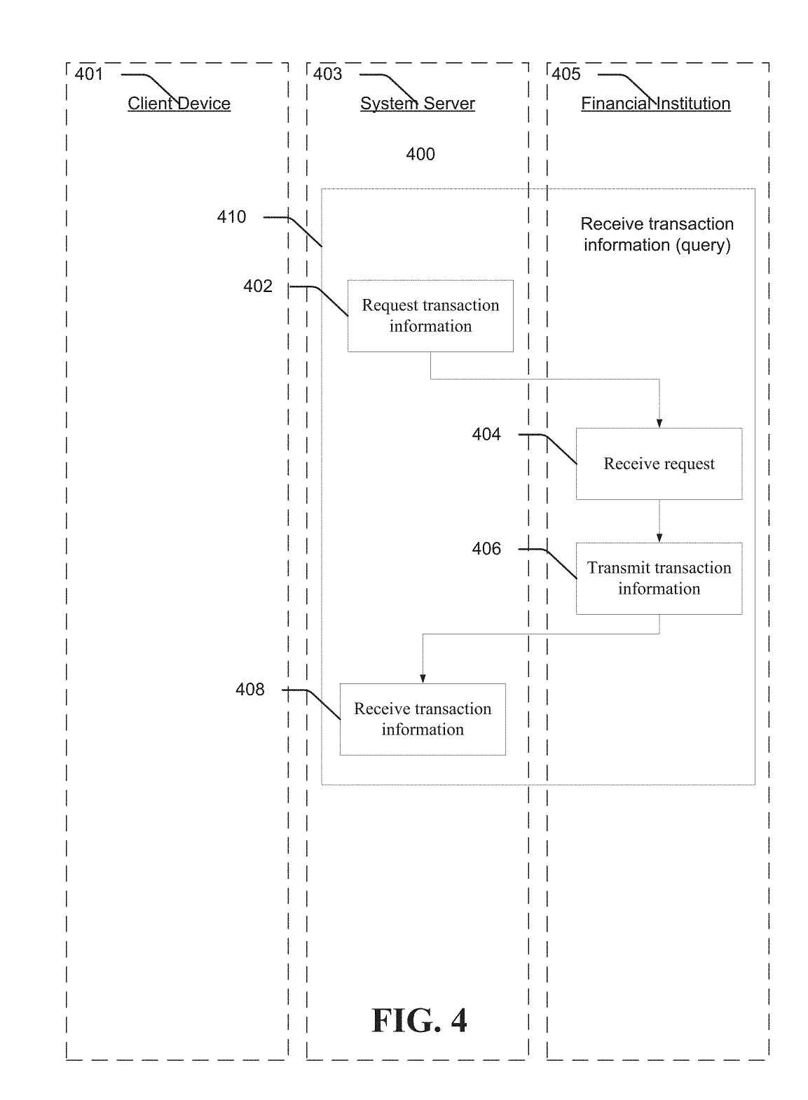

FIG. 4 illustrates an example process flow for receiving financial transaction information initiated by a request from a system server 403 in accordance with this disclosure. In particular, FIG. 4 depicts aspects of a method 400 for receiving transaction information in operation or functioning of a system 410. The method 400 may include requesting 402 transaction information from a financial institution 405. The requesting 402 may include the system 410, via the system server 403, querying the financial institution 405 for transaction information. The financial institution 405 may include a financial institution server and a financial institution information database (not shown). The method 400 may also include receiving 404, by financial institution 405, a request for transaction information. The method 400 may further include transmitting 406 transaction information responsive to the request by the financial institution 405 to the system server 403. In addition, the method 400 may include receiving 408 transaction information by the system server 403 from the financial institution 405. It will be understood that the system 410 depicted in FIG. 4 may include or may be in communication with one or more client devices 401. It will also be understood that the client device 401 may be a wireless electronic device 30 (as shown in FIG. 2), such as a smartphone, wireless tablet, or other suitable wireless smart device.

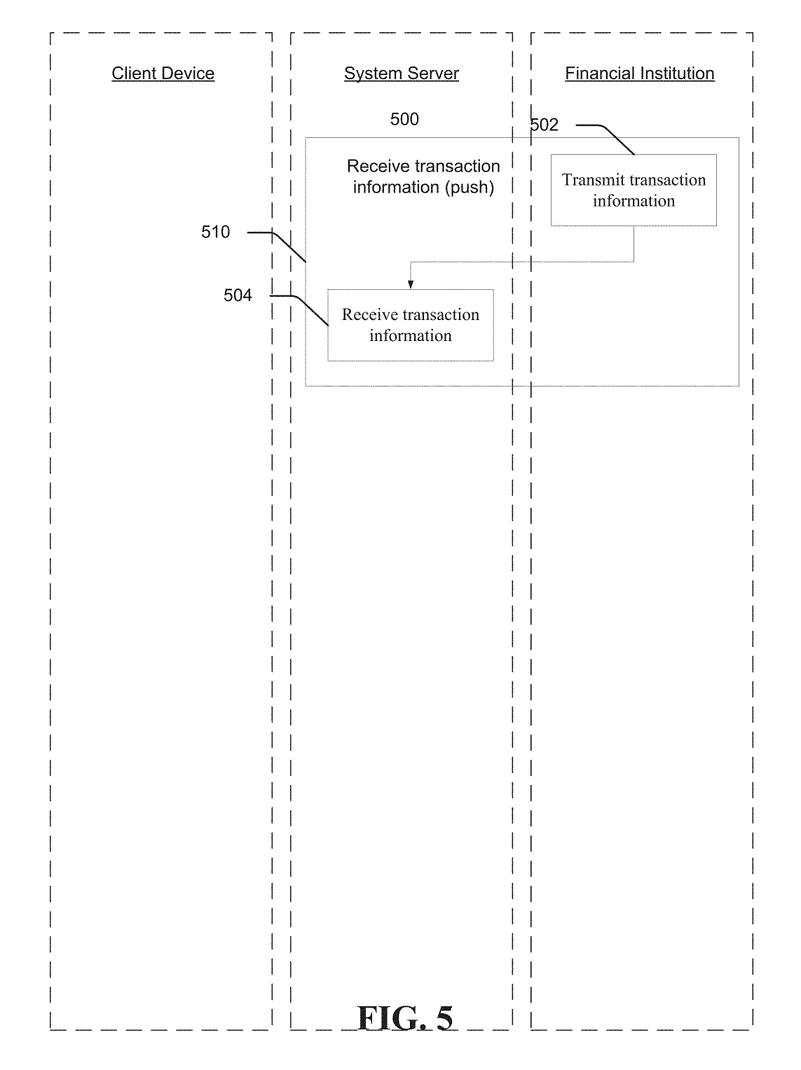

FIG. 5 illustrates an example process flow for receiving financial transaction information pushed to a system server by a financial institution in accordance with this disclosure. In particular, FIG. 5 depicts aspects of a method 500 for receiving transaction information in operation or functioning of a system 510. It will be understood that the method 500 and the system 510 may be identical to the method 400 and the system 410 of FIG. 4, except as otherwise described here or illustrated in FIG. 5. As shown in FIG. 5, the method 500 may include transmitting 502 transaction information by the financial institution to the system server, such as by pushing the transaction information from the financial institution to the system server. The method 500 may also include the system server receiving 504 transaction information transmitted from the financial information. It will be understood that, in some embodiments, the method 500 may include receiving transaction information transmitted by the financial institution without the system server first requesting the transaction information or querying the financial institution, such as by the financial institution pushing transmissions of the transaction information to the system server. In accordance with the method 500, the financial institution may push transaction information to the system 510. Once the system 510 receives the transaction information from the financial institution, the system server may store and use the transaction information. Such a method 500 may enable the system server and the system 510 to receive financial transaction information and may be referenced in several of the embodiments elsewhere described here.

FIG. 6 illustrates an example process flow for transferring funds within a system server based on user preferences in accordance with this disclosure. In particular, FIG. 6 depicts aspects of a method 600 for transferring funds in accordance with user distribution/allocation preferences in a system 610. The method 600 may include receiving 602 a request for transfer of funds by a system server of the system 610. The method 600 may also include determining 604 an allocation of funds according to a user preference by the system server of the system 610. The method 600 may further include transferring 606 funds according to the allocation. It will be understood that, in the transferring 606, funds may be transferred to, for example, asset accounts, savings accounts, financial accounts, investment accounts, a fund, third-party recipient accounts such as debt accounts like credit card accounts having an outstanding balance, or other accounts. In some embodiments, the transferring 606 may include virtual transferring by making entries representing such a transfer to a designated account in a ledger system associated with a user.

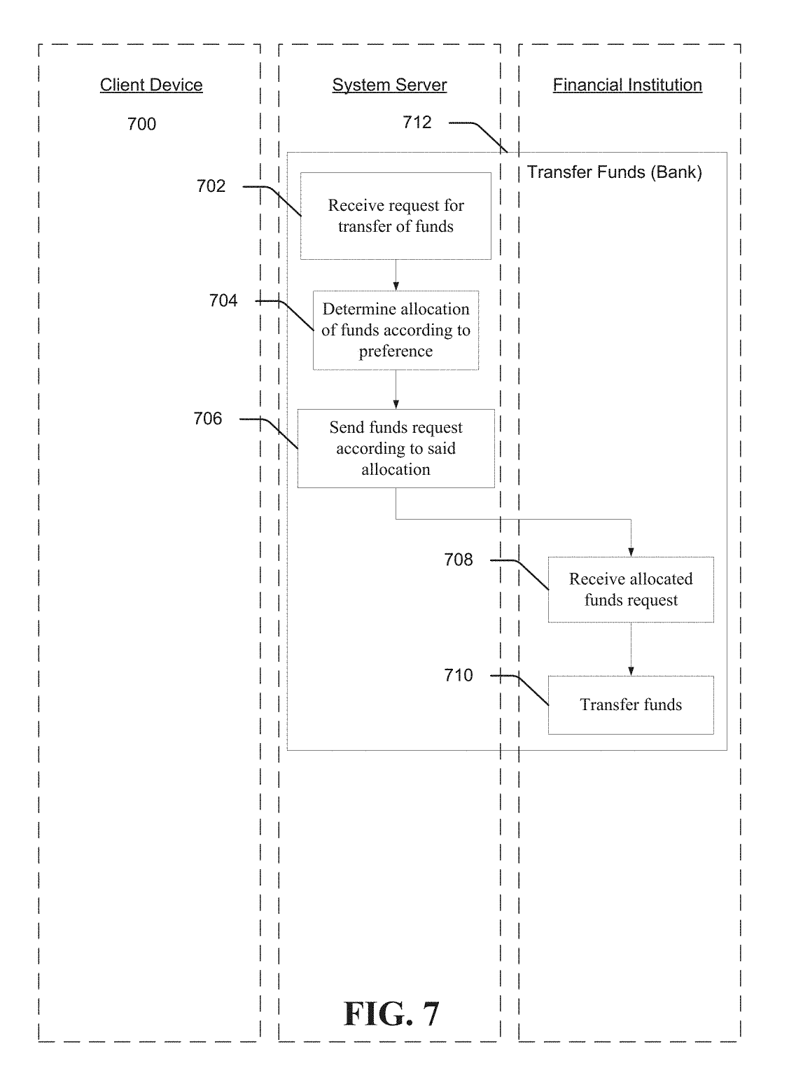

FIG. 7 illustrates an example process flow for transferring funds based on user preferences when funds are located in a financial institution in accordance with this disclosure. In particular, FIG. 7 illustrates a method 700 where funds are transferred by a financial institution based on requests sent to a system 712. It will be understood that the method 700 and the system 712 may be identical to the method 600 and the system 610 of FIG. 6, except as otherwise described here or illustrated in FIG. 7. As shown in FIG. 7, the method 700 may include the system 712 receiving 702 the request for transfer of funds and determining 704 an allocation of a fund distribution based on a user preference. The method 700 may also include sending 706 funds according to the allocation. The method 700 may further include receiving 708 an allocated funds request by the financial institution. In addition, the method 700 may include transferring 710 funds by the financial institution. Such a method 700 may enable the system 712 to initiate transactions corresponding to the transfer of funds and in relation to or based upon a weighted preference. Such a method 700 may be referenced in several of the embodiments described here.

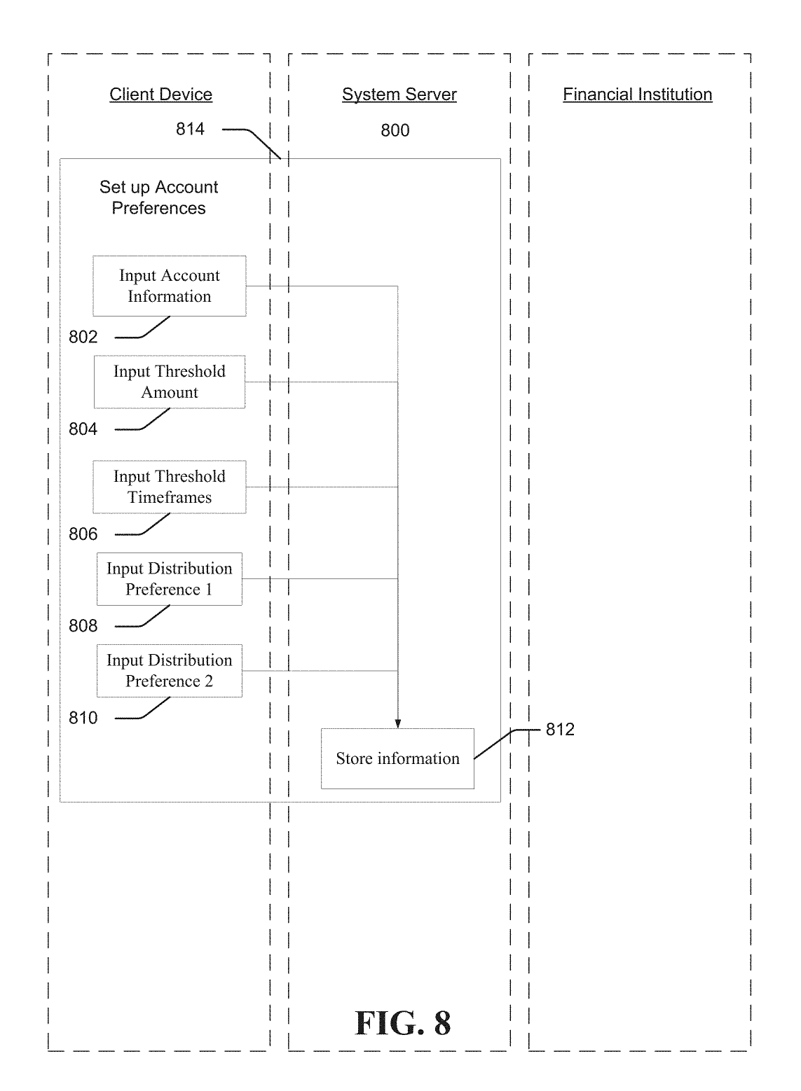

FIG. 8 illustrates an example information flow for providing and receiving user account information to a server in accordance with this disclosure. In particular, FIG. 8 indicates a data flow diagram for a method 800 for setting up account preferences for a user in a system 814. As shown in FIG. 8, the method 800 may include inputting 802 account information for a user into a wireless client device of the system 814, such as by receiving user input via a user interface of the client device, to provide the input account information from the client device to a system server of the system 814. The method 800 may also include inputting 804 a threshold amount for transactions for the user into the client device to provide the input threshold amount to the system server. The method 800 may further include inputting 806 threshold timeframes for the user into the client device to provide the input threshold timeframes to the system server of the system 814. The method 800 may also include inputting 808 a first distribution preference for the user into the client device to provide the input first distribution preference to the system server. The method 800 may further include inputting 810 a second distribution preference for the user into the client device to provide the input second distribution preference to the system server. In addition, the method 800 may include storing 812 input information for the user in the system server of the system 804, where the input information may include the account preferences and account information, threshold amounts, threshold timeframes, and distribution preferences. It will be understood that such user account information may include financial account information, amount thresholds, timeframe thresholds, and distribution/allocation preferences. Once received, the system 814 may store the user account information. User account information may be inputted into the system 814 in any number of suitable ways, including through the use of particular systems/methods described below.

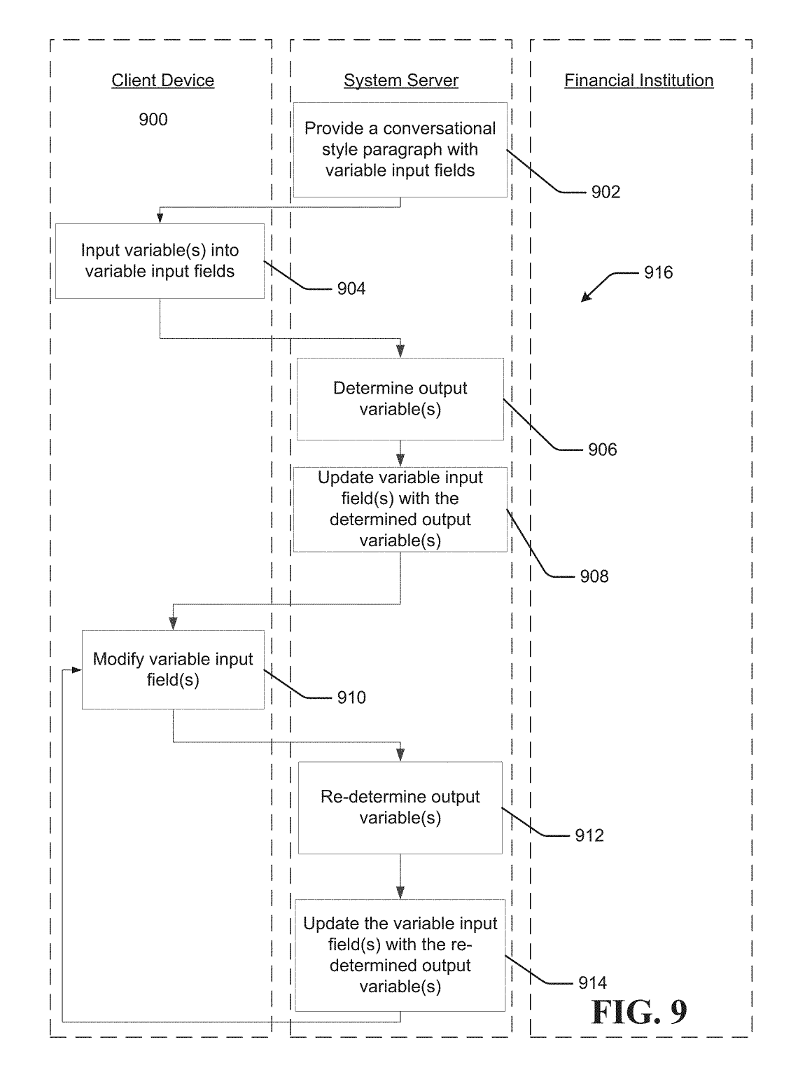

FIG. 9 illustrates an example process flow for receiving and outputting modifiable input variables in accordance with this disclosure. In particular, illustrated in FIG. 9 is a method 900 for displaying a final output in a conversational style paragraph and allowing variable modifications to be received within the conversational style paragraph itself from inputs, such as user inputs, via operation of an automated system 916. Such a method 900 may provide for the condensing of critical information into an intuitive and interactive medium in the system 916. It will be understood that the method 900 may be performed by operation of any suitable system 916 having an arrangement or configuration operable to perform the method 900 as disclosed.

In the example shown in FIG. 9, the method 900 may include a system server of the system 916 providing 902 a client device with a conversational-style paragraph having fields for input of variables. This could be done in response to a request initiated by a user of the client device. The fields may be resolvably linked to one another, meaning that variables that may be inputted into one or more of the fields may allow for the determination of variables corresponding to other fields through the application of one or more equations. The input fields may have a bound range of possible inputs. The system 916 may then identify a user input, such as haptic contact with a touchscreen interface, to interact with an input field. Responsive to user interaction with an input field, the system 916 may call a variable selector tool, such as a slider bar, a multiple selection choice prompt, a fund allocation tool described below, etc. The method 900 may also include the client device receiving 904 an input selection for a variable relating to an input field. The method 900 may further include determining 906 output variables. In some embodiments, the determining 906 may include performing internal calculations when sufficient input selections for the variable fields are available or determined, such as by the system server performing such internal calculations. The method 900 may also include the system server updating 908 output variables in variable input fields. The method 900 may further include the client device modifying 910 variable input fields in relation to user input. The method 900 may also include the system server re-determining 912 output variables. In addition, the method 900 may include updating 914 variable input fields with re-determined output variables. The system 916 may fill one or more of the variable fields with outputs based on the calculations involving the user-determined input selections. In some embodiments, the last input that was varied may be bound, while the other variables may be resolved or solved for mathematically in order to optimize an equation within the paragraph form itself. From updating 914, the re-determined output variables may be provided to the client device and further may be displayed on the client device.

In some embodiments, the system 916 to implement the method 900 may request inputs from a user, may display a final output in a conversational-style paragraph, and may allow inputted variable modification and outputted variable update within the paragraph itself. Furthermore, the mechanisms called to allow for user input of a bound variable into a field may be arranged so that the called mechanism (slider bar, etc.) does not occlude the conversational-style paragraph.

In some embodiments, as a financial example, the method 900 may include the output of a conversational-style flow, which may look like the following:
‘Congratulations John Doe, you have taken a giant step in securing your financial future. In 35 years you will be retiring, and your expected saved funds should be $1,000,000, which is enough to payout $5,000 per month!’
   Note, however, that the methods and systems described here are not limited to the financial sector and may be used in any suitable application requiring bound user inputs and providing outputs related thereto.

In the above paragraph, the underlined areas may correspond to fields that may receive input variables from the user or display output variables determined by the calculation. Each field area may be touched for modifications in real time (keyboard input, sliders, toggles, weighting tool, etc.), which when modified may cause the system to execute real time calculations that can be displayed in other fields without the need for refreshing the entire paragraph. For example, if the user wants to change the field associated with the future value from $1,000,000 to $1,500,000, he or she may tap the field having $1,000,000 in it and use a scroll/slider bar to choose the new value. Upon this single change, the newly-modified field may be bound/constrained, and the rest of the equation may be solved for any unknown variables. For example, the equation may solve for a new contribution rate, and the paragraph may be displayed with the newly-calculated contribution rate outputted in the corresponding field. Therefore, the following output may be displayed:
‘Congratulations John Doe, you have taken a giant step in securing your financial future. We have processed your modification. In 35 years you will be retiring, and your expected saved funds should be $1,500,000, which is enough to payout $7,000 per month! Your contribution rate will now be 12% per paycheck, click confirm below.’

In some embodiments, the method 900 may include the inputting 904 of variables, the updating 914 of re-determined output variables, and combinations thereof, by structuring input and output forms in order to simplify the data input, modification, and output process for the user of the system 916. Also, in some embodiments, the providing 902 may further include providing an intuitive and interactive conversational-style written communication system so that overall user engagement may be increased, such as by gaining attention of the user or communicating input and output variables in a preselected context that may reduce perceived complexity of information presented. In some embodiments, the system 916 and the method 900 may provide the option for the user to change any inputs within the paragraph and have the outputs responsive thereto displayed in real-time.

In some embodiments, the method 900 may include the inputting 904 of variables, the updating 914 of re-determined output variables, and combinations thereof, by receiving bounded user input variables and displaying resultant output variable in a text field. Also, in some embodiment, the method 900 may further include the inputting 904 of variables, the updating 914 of re-determined output variables, and combinations thereof, by receiving bounded user input variables in an unbounded text structure and unbounded textual context, without informing the user that the bounded user input variables are so bounded. Further, in some embodiments, the method 900 may include the updating 914 of re-determined output variables in an unbounded text structure and unbounded textual context, without informing the user that the bounded user input variables are so bounded. Moreover, in some embodiments, the method 900 may further include displaying resultant output variables in a text field having an unbounded text structure and unbounded textual context, without informing the user that the bounded user input variables are so bounded. Also, in some embodiments, changes to the displayed user input variables and a resultant output variables may be performed within the paragraph structure of the text. Further, in some embodiments, the output variable may be modifiable such that, when modified by a user, the associated input variables are recalculated and displayed as new output variables. Beyond that, in some embodiments, the output variable may be modifiable such that, when modified by a user, the associated input variables are recalculated and displayed as new output variables, both in an unbounded text structure and unbounded textual context without informing the user that the bounded user input variables are so bounded. In addition, in some embodiments, the recalculation and displaying of the resultant variables may be performed in real time.

In some embodiments, the system 916 and the method 900 may include text field changing, such as to warn the user of input of an invalid variable, if one or more of the input variables fall outside of acceptable parameters. Also, in some embodiments, values of at least some of the user input variables and resultant output variables may be compared to established ranges of acceptable parameters. It will be understood that, in some instances where values of at least some of the user input variables and resultant output variables may be compared to established ranges of acceptable parameters, such user input variables may be bounded input variables and such resultant output variables may be bounded output variables. Further, in some embodiments, system 916 and method 900 may include combinations of bounded input variables and bounded output variables.

In some embodiments, the method 900 may include the user input of numeric variables, and a resultant output numeric variable may be updated and displayed at locations embedded into the text field. As the number of variables increase, so too do the permutations of calculations with which they can be solved. Therefore, at some point, it may be beneficial to determine a system/method for binding and constraining the variables according to a hierarchy. In some embodiments, the system 916 and the method 900 may include binding and constraining the variables according to a hierarchy. Such a constraining hierarchy may benefit from the ability to update responsive to interaction, thereby learning from the user's actions.

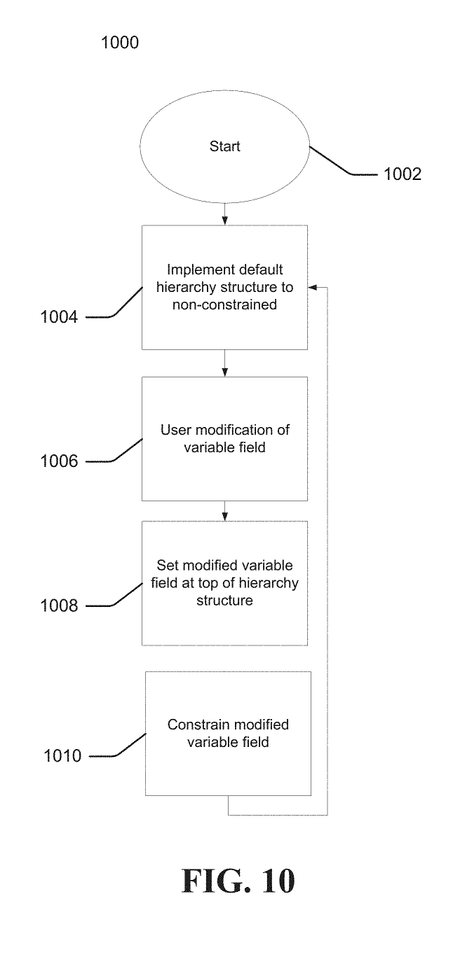

FIG. 10 illustrates an example method 1000 of structuring a hierarchical constraining loop for modifiable input and output fields in accordance with this disclosure. In particular, in some embodiments, the method 1000 for updating a hierarchy of variables may be provided. After starting 1002, the method 1000 may include implementing 1004 a hierarchical structure for determining which fields are most likely to be bound or constrained. Initially, such a system may have a default hierarchy order that will be applied to any fields that are non-constrained. The method 1000 may also include receiving or modifying 1006 a user modification of a variable field. The method 1000 may further include setting 1008 a modified variable field at the top of the hierarchical structure. In addition, the method 1000 may include constraining 1010 the field corresponding to the modified variable at top.

If desired, the method 1000 may include looping back or returning to the implementing 1004 for updating the hierarchy in response to a user's input selection. The most recent input field that the user has modified may be moved to the top of the hierarchy and constrained. If the user updates a subsequent input field, that field can then be placed at the top of the hierarchy and constrained. The higher the field's position within the hierarchy, the less likely that field is to be modified responsive to the input or modification of a different field. This hierarchy determination mechanism may be iterated, with the last field modified moved to the top of the hierarchy and constrained and any non-constrained fields being ordered within the hierarchy based on the default hierarchy order. Therefore, the most recently modified field may be the least likely field to be updated via recalculation, the second most recently modified field will be the second least likely field to be updated, the third most recently modified field will be the third least likely field to be updated, and so on. Any fields that have never been modified by the user may remain non-constrained and therefore subject to the default hierarchy order. This hierarchy determination mechanism may eventually overwrite the default hierarchy if enough of the variables are modified, allowing the system to progressively adapt its hierarchy responsive to user priorities. Until then, any fields that have not been bound or constrained by due to user interaction can remain with their likelihood of modification dictated by the default hierarchy.

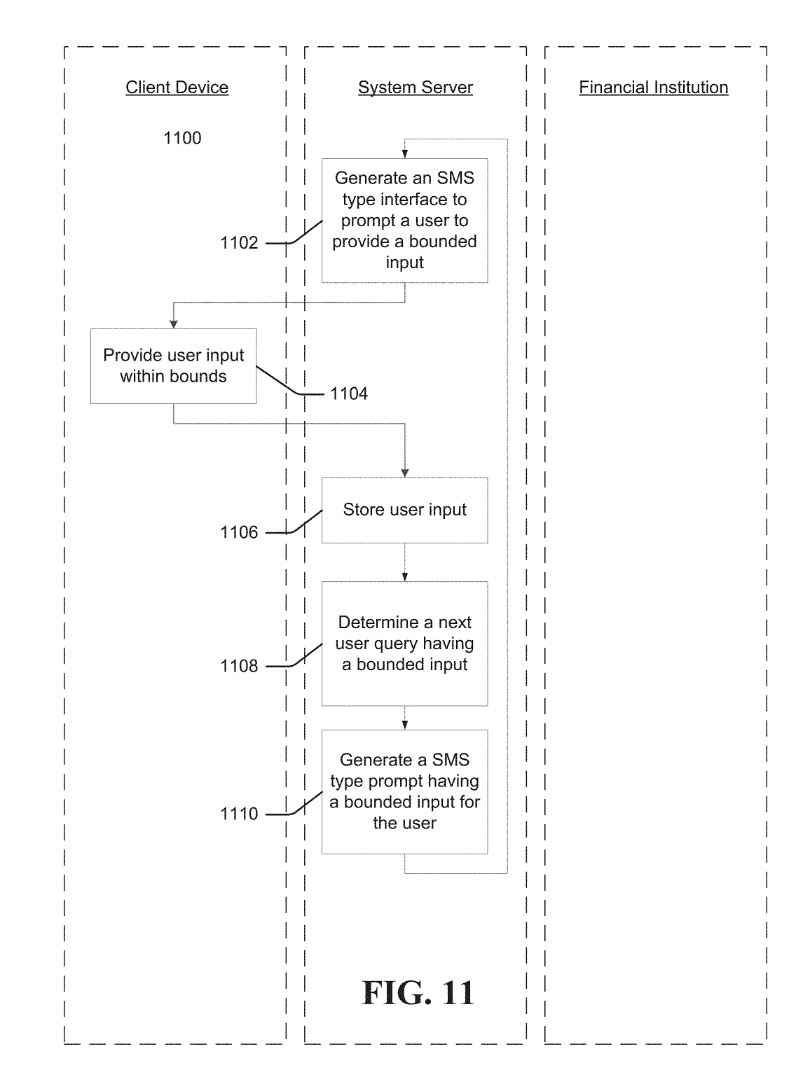

FIG. 11 illustrates an example process flow for obtaining user inputs via a conversational-style interface using SMS-type context cards in accordance with this disclosure. In particular, illustrated in FIG. 11 is a method 1100 for invoking a data capture by a system through use of SMS-type context cards. It will be understood that the method 1100 may be performed by operation of any suitable system having an arrangement or configuration operable to perform the method as disclosed here.

In some embodiments, the method 1100 may include a design and implementation that may request inputs from a user with an interactive style that may mimic, in certain aspects, SMS-style text messaging but in a context card format. In some embodiments, the inputs provided by the user may drive the system model and, as a result, a customized SMS-type reply may be generated responsive thereto. In some embodiments, the contexts cards that fill the space of the SMS-type user reply may be interactive in a nature that may allow for modifiable inputs to be interacted with in order to process a change. Depending on the implementation, single finger operation, keyboard input, and/or voice-activated input may be utilized by a user.

In this example, the method 1100 may include generating 1102 a user prompt requesting an input from a user. The prompt may guide the user by requesting that he or she select from or provide an input having a finite number of possible selections (bound input). Such inputs may be selected through, but are not limited to, use of a slider bar, a ranking of multiple items, a weighting tool discussed below, a selection between items, etc. The method 1100 may also include the user providing 1104 input within the bounds. For instance, the user may select an input through any suitable user interface, such as haptic contact with a touch screen or clicking on an icon with a mouse. Once the input is provided, the system may then store 1106 the information associated with the input. The system may then determine 1108 a next prompt to provide to the user. The next prompt may or may not be based on the information received from the user responsive to prior prompts. The system may then query the user for additional information in a guided process that mimics a conversational style but which may be constrained within bounds provided or determined by the system. If additional inputs are to be collected by the system, the steps of prompting a user for an input, receiving an input from the user, and storing the associated information may be repeated. If no further information is required, the process can progress, such as per a decision tree, for providing prompts/responses that do not solicit/require user input responsive thereto. The system may then perform internal calculations based on the input. The system may use information provided by the user to perform calculations, the results of which may then be presented to the user in the same SMS-type context cards.

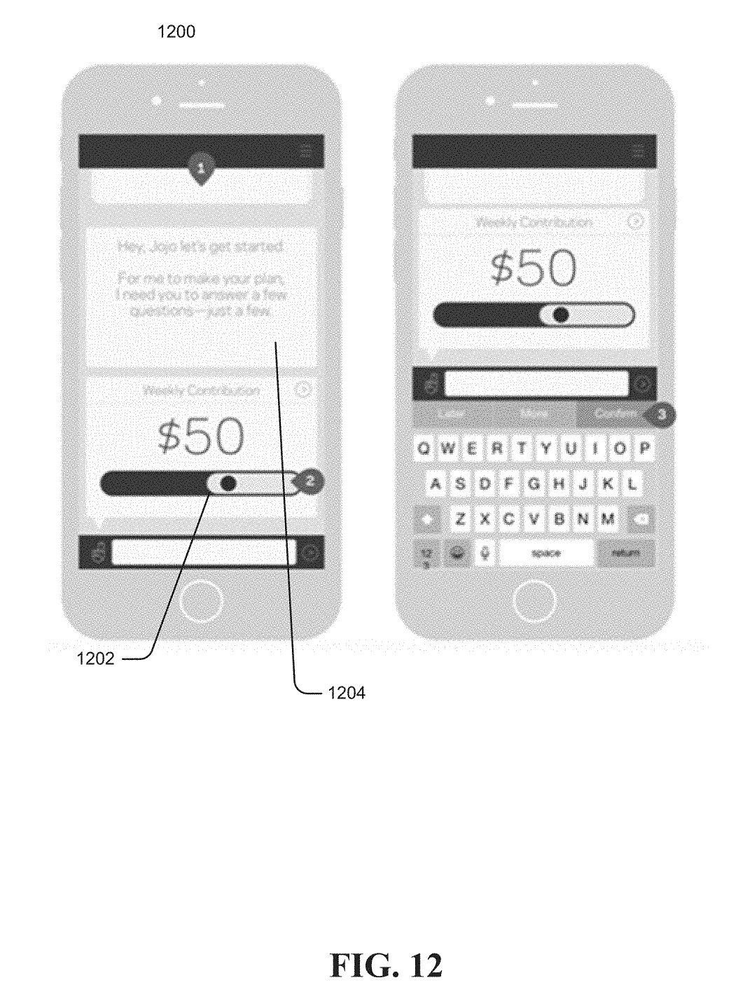

FIG. 12 illustrates an example string of SMS-type context cards in accordance with this disclosure. In some embodiments, a system interacting with a user while utilizing a method in which the system gathers user inputs may be optimized to reduce user complication while increasing user engagement. For example, as illustrated in FIG. 12, a system 1200 may support the presentation of prompts and receipts of user inputs, each of which can be presented in the form of an SMS-type message. These prompts and receipts may be presented together in a logical order, such as chronologically or according to some other rule(s), so as to form an SMS-type message string. Such a presentation may aid in engaging users due to its intuitiveness, familiarity, and user interactivity and may therefore result in increased data gathering when compared to systems having a less familiar presentation. SMS-type message strings may be grouped, stored, and presented based on a common subject of messages in the string.

In some embodiments, the system 1200 may allow a user to dictate direction of a process openly. Also, in some embodiments, the system 1200 may perform a method that may guide a user through a predetermined flow, which may follow a decision tree that may be informed by the inputs provided by the user. Further, in some embodiments, the interface may give the perception that the choices may be unbound so as to best engage the user, but which may in reality be guided by the system.

FIG. 12 depicts a conversational-style SMS-type string 1204, which includes a slider bar 1202 or other input mechanism. The example illustrated in FIG. 12 is in the context of displaying financial information. However, the SMS-type context card information acquisition method and system may not be limited to the financial sector and may be used in any suitable application. In some embodiments, the SMS-style threading or a container of each conversation may be mimicked, but instead of each thread being a separate contact name or number, the threads in the implementation may represent other groupings, such as categories of user inputs.

In some embodiments, the system input and output methods may be based upon basic input and output forms and may require use of a keyboard. Also, in some embodiments, the system 1200 may be intuitive and interactive, thereby promoting increased user engagement. Further, in some embodiments, the sub-categories of previously entered data or topics may be easily retrieved through the SMS-style threading categories, which may be presented in an upper tier menu.

In some embodiments, a method involving the use the system 1200 or similar system may include obtaining user inputs using a computing device having a touchscreen interface. The method may also include prompting a user to engage with a touchscreen-engageable input field. In some embodiments, the method may include prompting a user to engage with a touchscreen-engageable input field to select from a bounded set of potential inputs. Also, in some embodiments, an embedded bounded input may be displayed in association with the engageable input field. Further, in some embodiments, the engageable input field may be displayed within a context card. The context card may have, for example, the appearance of an SMS-style text message. In some embodiments, the engageable input field may be displayed with a context card in a manner in which the input may be modified by touching the touchscreen-engageable input field at the displayed input presented within the context card. Also, in some embodiments, a conversational style paragraph may be provided by the context card, the conversational style paragraph having in it the embedded bounded input. In addition, in some embodiments, the engageable input field may be provided by a predefined input, such as a slider bar, button, selection wheel, weighting tool, etc.

In some embodiments, the context card may be selected in relation to input of the user from a previously established set of context cards according to the user's previous inputs. Also, in some embodiments, the context cards may be presented in an order that guides the user through a logical flow of information inputs, and may have the potential values of the engageable input fields presented to the user be bounded. Further, in some embodiments, the context cards may be presented to provide the perception that user choices of the engageable input fields are not bound or guided, or are instead guided by the user. In addition, in some embodiments, the context card may be a reply to a user input.

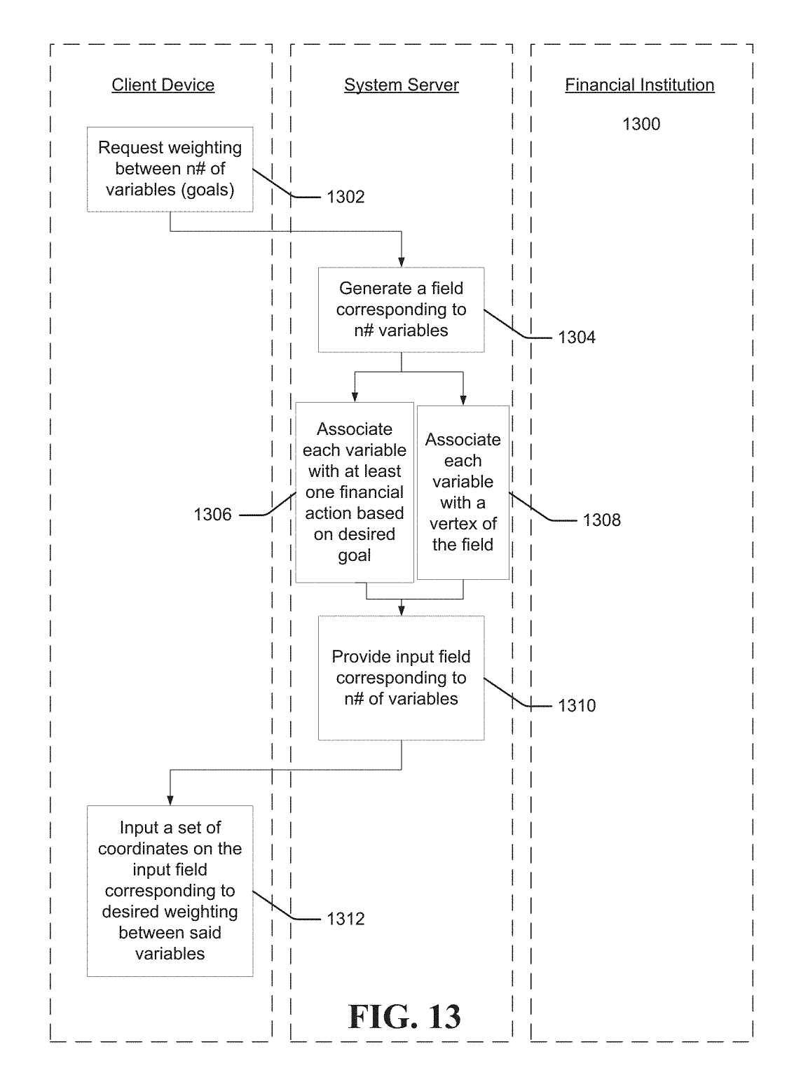

FIG. 13 illustrates an example process flow for creating a weighting tool and receiving a weighting preference in accordance with this disclosure. In particular, illustrated in FIG. 13 is a method 1300 for determining a weighting preference between a plurality of variables through use of a single point interface. While discussed in relation to financial matters, it should be noted that the method 1300 and its related system may determine a weighting preference between a plurality of variables in any suitable context. It will be understood that the method 1300 may be performed by operation of any suitable system having an arrangement or configuration operable to perform method 1300 as disclosed here.

When a generic financial system is created, a user may be in charge of balancing his or her own accounts for the goal of reducing the user's current liabilities and growing the user's wealth (such as savings or retirement) while also saving for life experiences (such as travel or purchase of a new product). Making the hard choice of determining monetary allocation may be very difficult for the user, and transferring funds according to their weighting preferences may be complicated. A system and method 1300 as disclosed here provide users with a simple and interactive way to establish a weighting preference between variables, which may correspond to the different goals that a user may want his or her financial account management system to address.

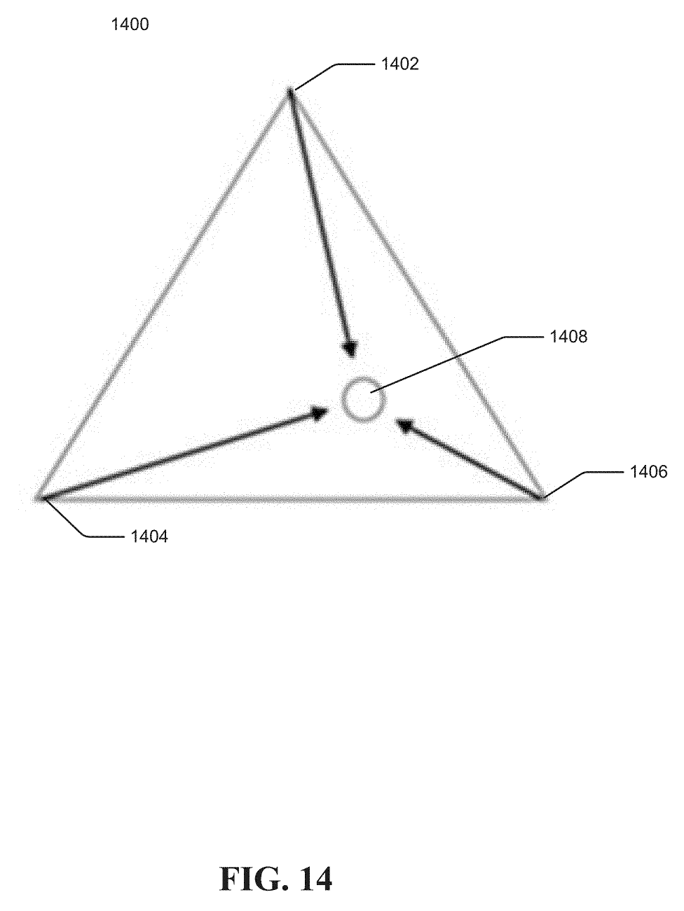

As shown in FIG. 13, the method 1300 provides users with a visual field (represented by a polygon as shown in FIG. 14 of a corresponding system 1400), where each of the vertices (1402, 1404, and 1406 in FIG. 14) of the polygon represents a specific variable that may be associated with a financial goal and/or another desired outcome. The method 1300 may include requesting 1302 weighting between n# (n number, a variable number) of variables, such as goals or actions. The number of variables of the weighting system may correspond to the number of vertices of the polygon. The method 1300 may also include generating 1304 a field corresponding to the n# of variables. The method 1300 may further include associating 1306 each variable with at least one financial action based on a desired goal and associating 1308 each variable with a vertex of the field. The method 1300 may also include providing 1310 an input field corresponding to the n# of variables. In addition, the method 1300 may include inputting 1312 a set of coordinates on the input field corresponding to desired weighting between the variables.

FIG. 14 illustrates an example visual field and selection point corresponding to a weighting tool having three variables in accordance with this disclosure. Referring to FIG. 14, the system 1400 may include the polygon having positioned inside of it a selection point 1408, which the user may be asked to position relative to the vertices 1402, 1404, 1406 of the polygon in order to reflect a relative weighting of the user's desired preferences. The shifting of the selection point 1408 relative to the vertices 1402, 1404, 1406 corresponds to a relative weighting of the importance of the goal/desire in the eyes of the user. Shifting the selection point 1408 closer to one vertex 1402, 1404, or 1406 increases the weighting of the goal/desire corresponding to that vertex. Alternatively, the shifting of the selection point 1408 farther away from a vertex 1402, 1404, or 1406 reduces the weighting of the goal/desire corresponding to that vertex (i.e. the distance between the selection point 1408 and the vertices 1402, 1404, 1406 are inversely correlated with the relative weighting of the variables associated therewith).

The system 1400 and method 1300 may receive a desired number of variables via a user input and may generate a visual field corresponding to the requested number of variables. In an example having three variables, the visual field presented may include an equilateral triangle on an x/y plane (see FIG. 14). Each of the three points or vertices 1402, 1404, 1406 of the triangle corresponds to a variable/goal. The user can select any location within the triangle in order to select his or her weighting preference between the three variables. The distance between the point of selection 1408 and each vertex 1402, 1404, 1406 associated with a variable determines the relative weighting of the goal associated with that variable. The closer the point of selection is to a vertex, the higher the weighting of that goal relative to those represented by the other vertices of the triangle. In some embodiments, all weightings should total to 100%.

In some embodiments, the system 1400 and method 1300 may allow the user to determine a weight for each of the three variables concurrently with a single point of input by the user selecting a point corresponding to x and y coordinates within the field. Also, in some embodiments, a selection point may be displayed. The selection point may be associated with the last location that the user interfaces with during touch or swipe interaction with the interface. Such user interaction with the field may be achieved through a suitable input method, such as through haptic interaction with a touchscreen interface.

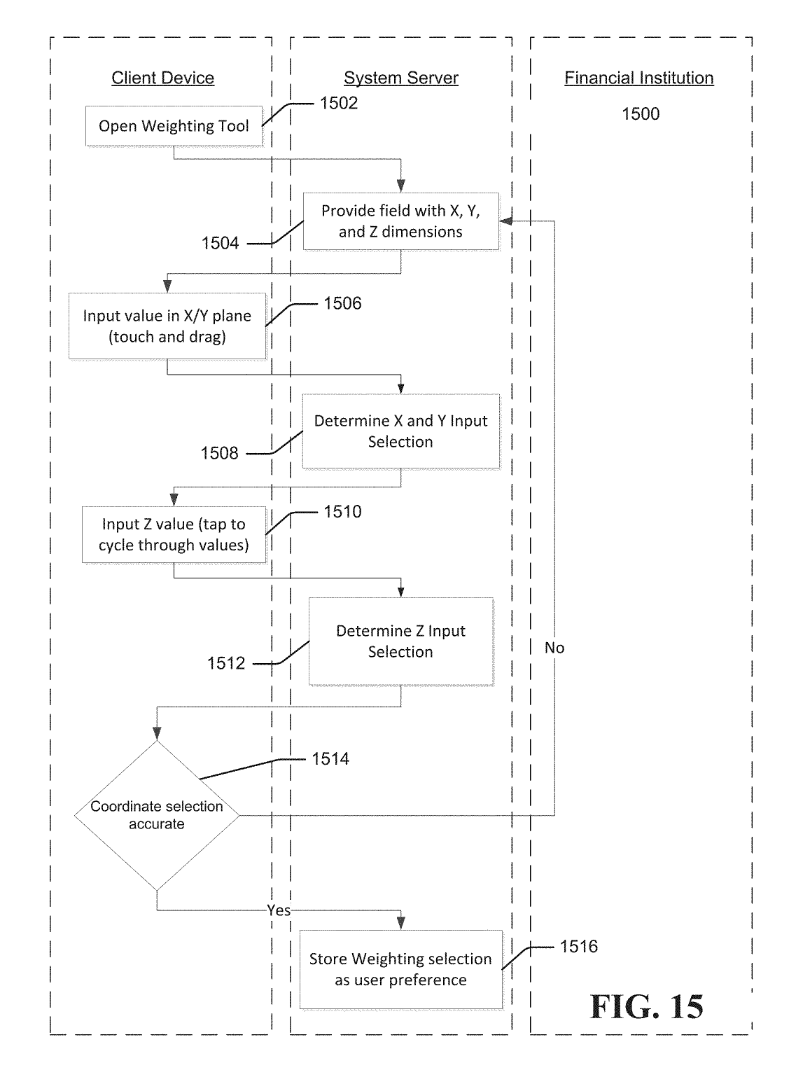

FIG. 15 illustrates an example process flow for determining a user weighting preference between four variables in accordance with this disclosure. As illustrated in FIG. 15, a weighting system and method 1500 may include a fourth variable. In such four-variable embodiments, a field may have an additional (z) dimension, thereby providing for a fourth vertex to be associated with the fourth variable. In such cases, the field can include a three-dimensional object, such as an equilateral triangular pyramid.

In some embodiments as shown in FIG. 15, a weighting tool is opened 1502, and a field with three dimensions is provided 1504. A position in the x/y plane is received 1506, and the selection of the x/y input is determined 1508. This supports the modification of three variables. The modification of a fourth variable corresponding to the vertex having a different z coordinate may be facilitated through a tapping 1510 interaction, such as with a touchscreen interface. Such a tapping 1510 interaction may allow for cycling through the possible available coordinate variables associated with the z-axis. Based on the tapping, a z input selection is determined 1512.

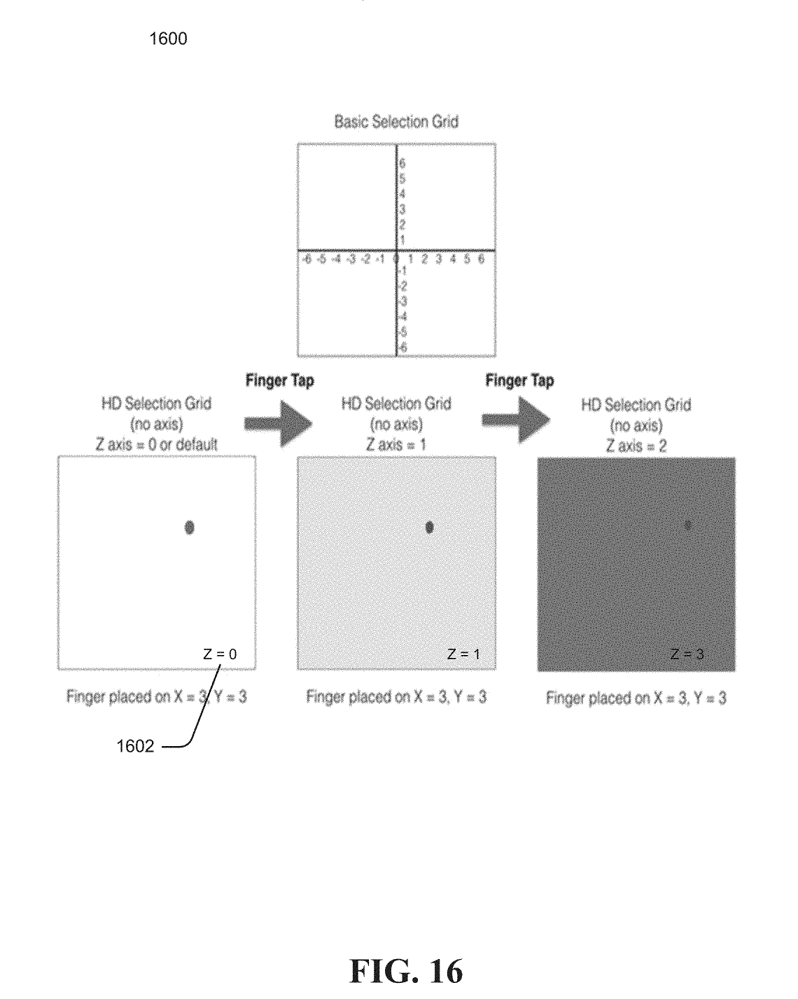

FIG. 16 illustrates an example series of visual fields depicting different stages of modification of a z-axis coordinate for a three-dimensional weighting tool in accordance with this disclosure. Each tap 1510 on the interface, which may be associated with a z coordinate variable modification of the selection point, may be linked to the display of a z coordinate variable value identifier 1602 shown in FIG. 16. In some embodiments, a method 1600 may include displaying of the z coordinate variable value identifier 1602, which may be a number corresponding to the current z coordinate of the selection point. Alternatively, the z coordinate variable value identifier may include a color identifier, which may be used to identify the current z coordinate variable of the selection point. In some embodiments, there may be a specific incremental value associated with each tap, where each tap may correspond to a modification of the variable associated therewith by the incremental value. As shown in FIG. 16, for example, each tap is associated with an incremental value of one (1) unit of the z coordinate variable.

Referring again to FIG. 15, the method 1500 may include confirming 1514 the accuracy of the coordinate selection by receiving user input, when a selection point coordinate has been established. According to the method 1500, the user may confirm that the coordinate selections are accurate. If the selections are not accurate, the steps from outputting the field to confirming that the coordinate selection is accurate may be repeated. If the selection is accurate, the selection may be stored 1516 in a memory of a system associated with the tool.

In some embodiments, the weighting system may not be binary. Thus, for example, a user may incrementally weight his or her preferences between the various variables. Also, in some embodiments, the variables may be associated with one or more financial accounts or financial goals. Examples of such financial goals may include but not limited to the following:

Debt Reduction—the goal is to eliminate some or all liabilities that the user currently has (credit card debt, student loans, house loans, etc.);

Wealth Accumulation—the goal is to grow the financial accounts as best as possible, which may include growing retirement accounts (ROTH, traditional, savings, health savings, etc.); and

Life Experience—the goal is to assist the user to save for items or events that might not necessarily be the smartest thing financially but that allow the user to blend financial responsibility with happiness. For example, such life experience preferences may include buying a boat, paying for a wedding or honeymoon, world travel, purchasing a house, etc. In some embodiments, life experience preferences may be events or purchases that are planned to occur prior to a period of retirement.

The disclosed weighting systems and methods may be configured for use through one or more of many potential user input devices without departing from the scope of this disclosure. The weighting systems and methods may be implemented on a touchscreen, where the user may physically press the point on the field corresponding to his or her desired weighting between the presented variables. Alternatively, the weighting system and method may be implemented on a computer-type interface, where a user may use an input device, such as a mouse, to select the point on the field corresponding to his or her desired weighting between the presented variables.

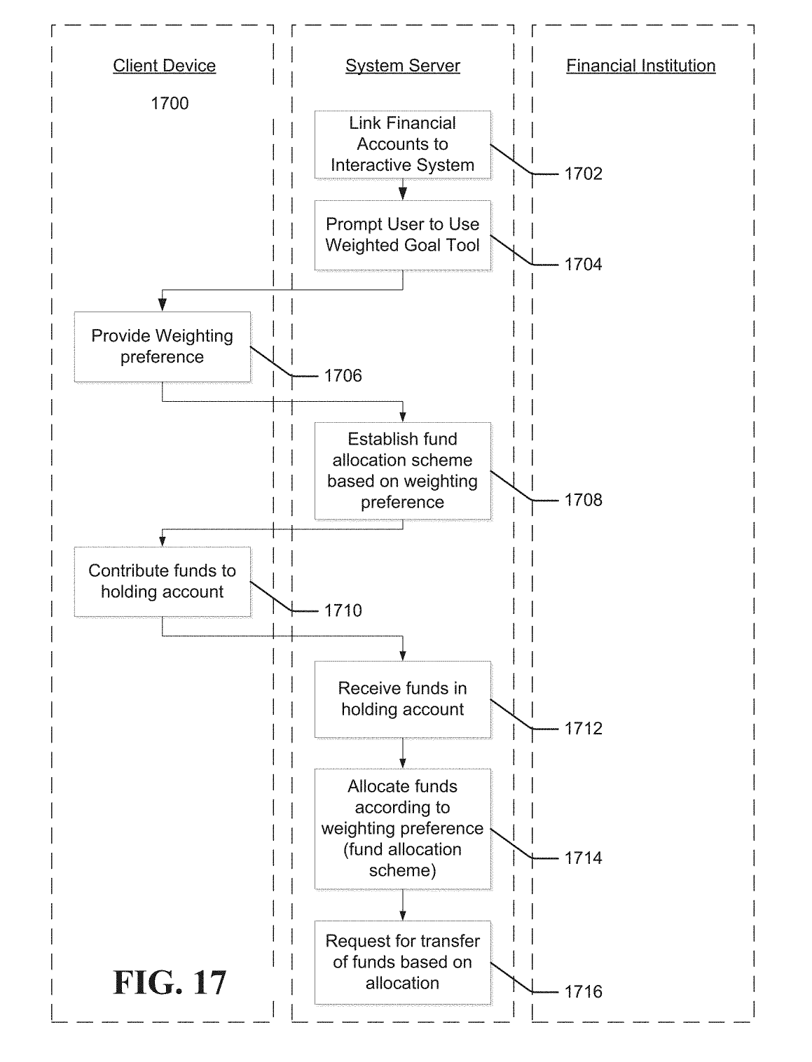

FIG. 17 illustrates an example process flow for distributing/allocating funds according to weighted user preferences in accordance with this disclosure. In particular, FIG. 17 illustrates a method 1700 for determining a weighting preference that may be used to determine the distribution and allocation of resources between accounts in order to achieve associated user goals. The method 1700 may include linking 1702 one or more financial accounts of a user to a system. The method 1700 may also include prompting 1704 the user to use the weighted goal tool (such as but not limited to the weighted goal tool described here) to establish one or more weighting preferences. The method 1700 may further include providing 1706 weighting preference by use of the weighted goal tool. The method 1700 may also include establishing 1708 a fund allocation scheme based on the weighting preference. In some embodiments, a system and method may use the user-inputted weighting preferences to at least partially determine the manner in which the user's financial accounts are managed. The method 1700 may further include contributing 1710 funds to an account, such as a holding account. The method 1700 may also include receiving 1712 funds in an account, such as the holding account. The method 1700 may further include allocating 1714 the funds according to the weighting preference. In addition, the method 1700 may include requesting 1716 a transfer of funds based on the allocation. In some embodiments, when the weighting of one variable/goal is greater than that of another, the management of the user's financial actions may be altered in order to reflect the fact that the user views one variable/goal as more important than another.

In some embodiments, the system and method may allow the user to link his or her financial accounts to the system, provide goals, and assign a weighting preference between the goals in order to optimize resource distribution between the goals. Once the associated data is provided, the system may funnel money into different allocated accounts based on the weighting preference for each goal. This system and method may help to simplify the manner in which users allocate and distribute their resources in order to achieve their varying goals.

As an example, once a weighting preference is established, the system may monitor when money is deposited into an account associated with the system and automatically allocate and distribute that money between accounts according to calculations based on the weighting preference. The method and system may be configured to not solely optimize for interest rate and cash flow but instead to take into account the personal needs of each user and his or her perceived value of each financial goal, such as reducing current liabilities, growing wealth (savings and retirement), and saving for life experiences. In some embodiments, weights inputted by the user may drive an equation in order to solve for the best method for fund dispersion in order to achieve the goals of the user as interpreted in view of the relative weighting of the variables associated with the vertices of the displayed selection polygon.

In some embodiments, the system and method may utilize calculations related to the weighting preference in the determination of the allocation and distribution of resources. In performing these calculations, the system and method may verify the APRs of all liability accounts, the estimated rates of return from wealth accumulation, and the associated cost of life experience events requested by the user to initially build an overall allocation/distribution model. The weights inputted by the user may drive the equation in order to solve for the best method for fund dispersion to reach the goals of the user. The examples previously mentioned and shown below may be based on three objectives previously mentioned. In some embodiments, the method and system may not be limited to the three objectives and may be thought of as a completely generic application of deciding between items and their associated weights in order to calculate fund allocations.

In some embodiments, the user may toggle the weighting of his or her resource allocation/distribution towards a plurality of variables/goals. As discussed, three variables/goals may include debt reduction, life experience, and wealth accumulation. In some embodiments in which the user goal of debt reduction is given a low weight, the distribution of funds may be as follows: if a typical contribution into an IRA is $300 per month, 45% may be filtered to life experience savings, 45% may be filtered to retirement accounts, and 10% may be filtered to reducing debt. In this particular example, the interest rate of each account has been ignored and not optimized for that allocation only. The system and method may make suggestions in order to help the user make smarter financial choices, but the decision may remain the user's responsibility.

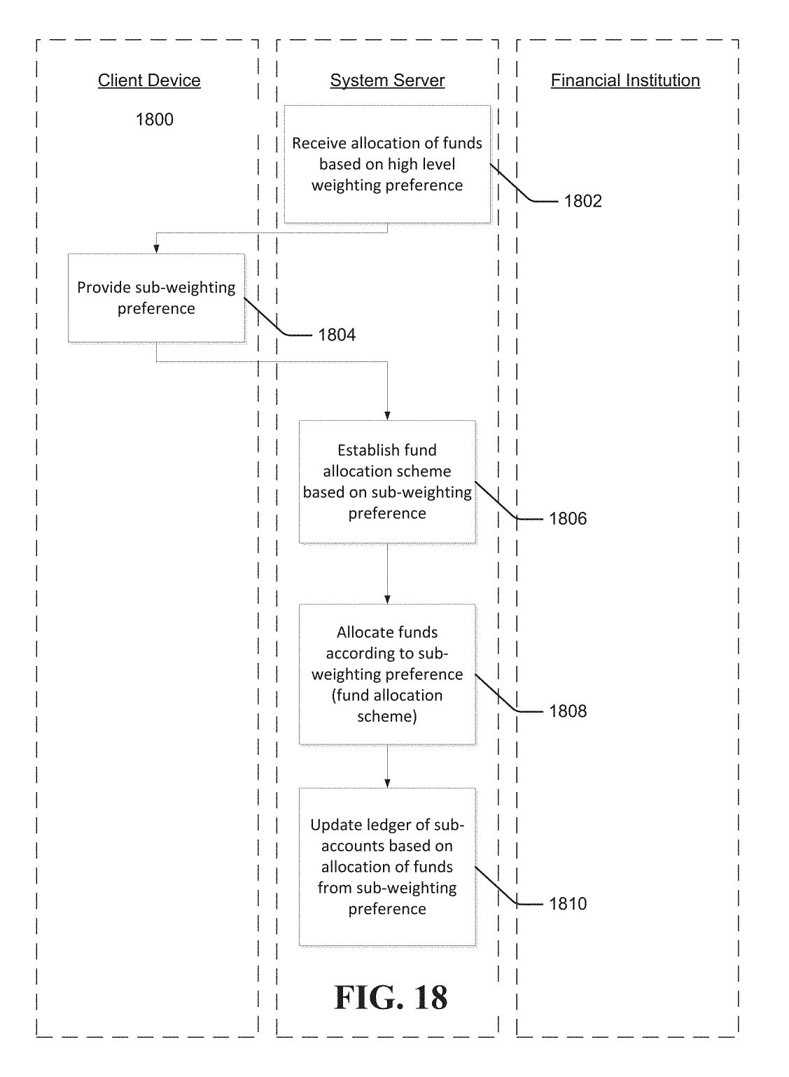

FIG. 18 illustrates an example process flow for the sub-distribution/allocation of funds according to weighted user sub-preferences according to a cascading weighting system and method in accordance with this disclosure. With reference to FIG. 18, in some embodiments, a method 1800 of distributing/allocating resources based on user inputted weighting preferences may include or allow for cascading. The method 1800 may include receiving 1802 an allocation of funds based on high-level weighting preference. The method 1800 may also include providing 1804 sub-weighting preferences. The method 1800 may further include establishing 1806 a fund allocation scheme based on the sub-weighting preferences. The method 1800 may also include allocating 1808 funds according to the sub-weighting preference. The method 1800 may further include updating 1810 a ledger of sub-accounts based on an allocation of funds from the sub-weighting preference. The method 1800 thus allows funds to be directed to a particular variable/goal of the original weighting preference and to then be sub-distributed/allocated into multiple financial accounts based on a separate weighting preference. For example, once resources have been allocated/distributed to the goal of life experiences, the system and method may then use a separate weighting preference to sub-allocate/distribute the funds between sub-goals included under the umbrella of life experiences (i.e. X % towards the purchase of a new bicycle, and Y % towards saving for a trip).

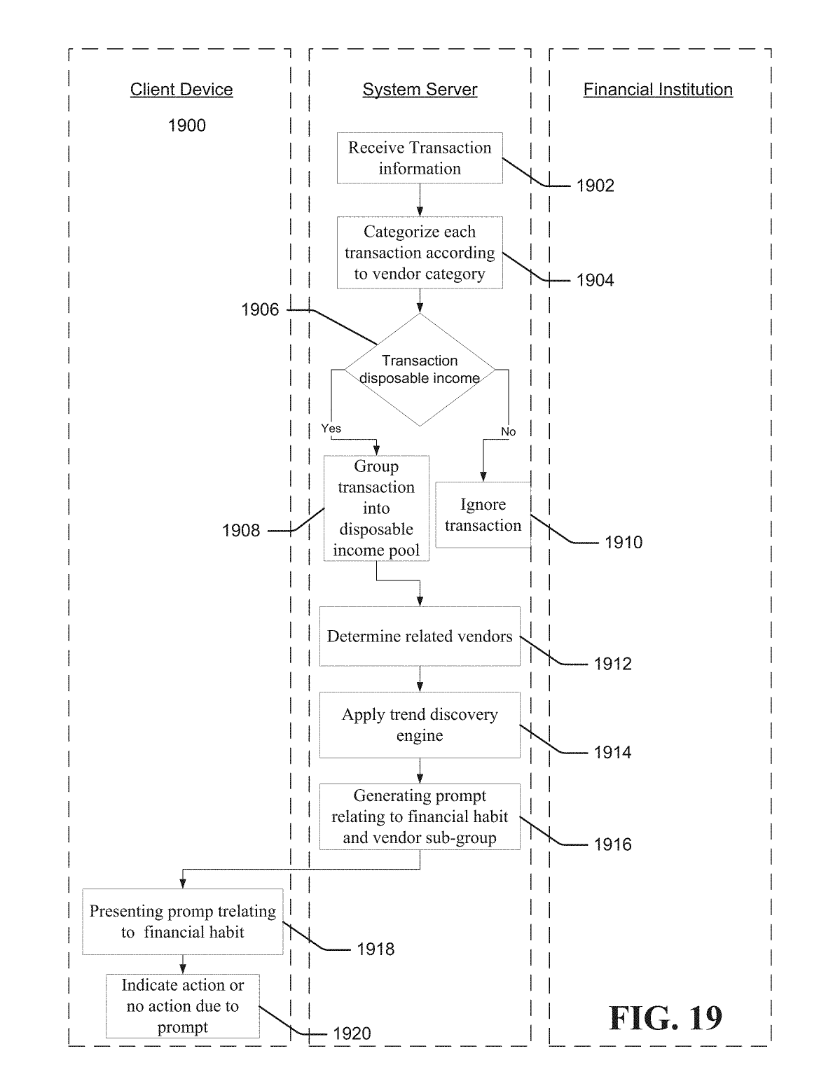

FIG. 19 illustrates an example process flow for suggesting modification of user behavior in relation to disposable income spending habits in accordance with this disclosure. In particular, illustrated in FIG. 19 is a method 1900 for providing a user with opportunities to save relative to purchasing tendencies. It will be understood that such a method 1900 may be performed by operation of any suitable system having an arrangement or configuration operable to perform the method as disclosed here.

A corresponding system and method 1900 may promote contributions to financial instruments designed to grow long-term wealth by either prompting a user to not make a purchase that would unnecessarily reduce his or her resources or by enabling the instantaneous transfer of money to a savings instrument at a point at which the system has identified an increased likelihood of an individual's willingness to make expenditures. Furthermore, the method 1900 frames the contribution in terms of a tangible item, such as one related to a transaction.

The method 1900 may include receiving 1902 transaction information, such as by linking financial accounts to a system. The system may be able to use the individual's account information to receive transaction information. Such transaction information may contain information related to a plurality of variables associated with the transaction, such as vendor type, transaction value amount, transaction time, etc. The system may be able to parse out these pieces of information and group, compare, and analyze them both individually and in any suitable combination.

In some embodiments, the method 1900 may allow for the visualization of potential savings from a change in a spending habit, which may include the system implementing operations that may help the user to make educated financial decisions based on his or her previous spending habits. A spending/financial habit may include, for example, a determined pattern of financial transactions for an entity, such as a user. The method 1900 may include categorizing 1904 each transaction according to vendor category. The method 1900 may also include identifying 1906 disposable income transactions. In some embodiments, the identification may track a user's day-to-day transactions to determine a user engagement that may be appropriate based on situational spending. In some embodiments, software may look at categories the user has been allocating his or her funds to recently and may prompt a statement in order to help the user make smarter financial decisions. The method 1900 may also include grouping 1908 disposable income transactions into a disposable income pool and ignoring 1910 non-disposable income transactions. The method 1900 may further include determining 1912 related vendors and applying 1914 a trend discovery engine to identify financial habits for a user.

Once the trend discovery engine has identified the user's financial habits, it may separate the habits into habitual transactions based on discretionary income, habitual transactions based on non-discretionary income, and non-habitual spending. The method 1900 may include generating 1916 a prompt relating to financial habits and vendor sub-groups. The method 1900 may also include presenting 1918 a prompt relating to a financial habit via a client device to the user. Once the system has identified a user's habitual spending habits based on discretionary income, the system may generate 1916 and send the prompt to the user, the prompt being designed to inform the user of the potential effects of the habitual discretionary transaction on his or her development of long-term wealth. The prompt may present the information positively or negatively.

In addition, the method 1900 may include indicating 1920 action or no action due to a prompt via the client device. For example, the system may notify the user that if one or more future habitual purchase amounts could be deposited (saved) in a user account instead of buying one or more future items with that money, the future value of his or her financial accounts will be positively affected by a displayed value. If the user does not choose to save during this instance (still makes the habitual discretionary purchase), the system can record this information to target the user on future repeat trips to this location or category of purchase. Note that the system may be provided with information used to determine a likelihood that transactions are related to necessary or discretionary spending.

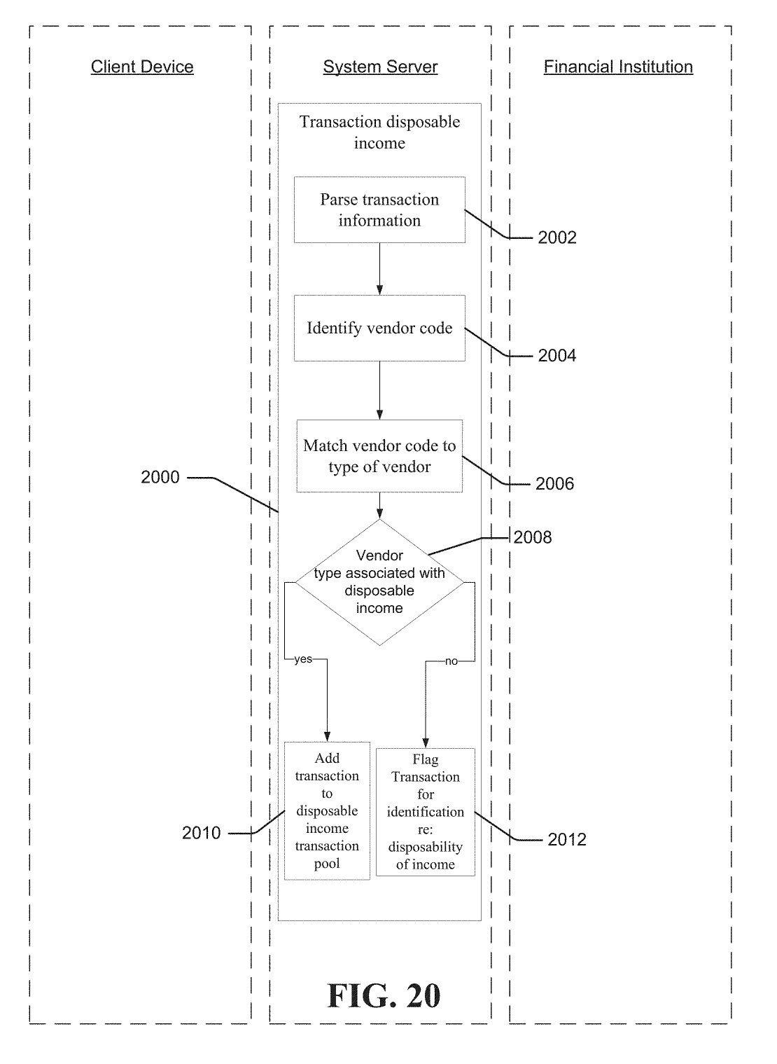

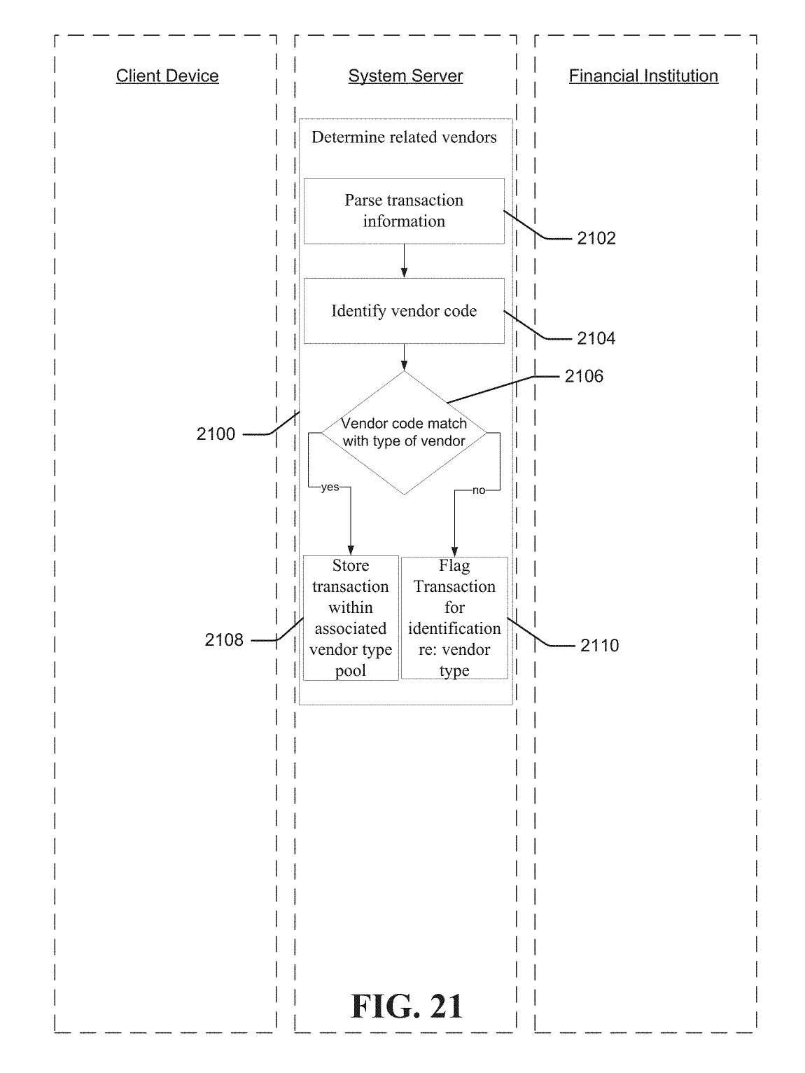

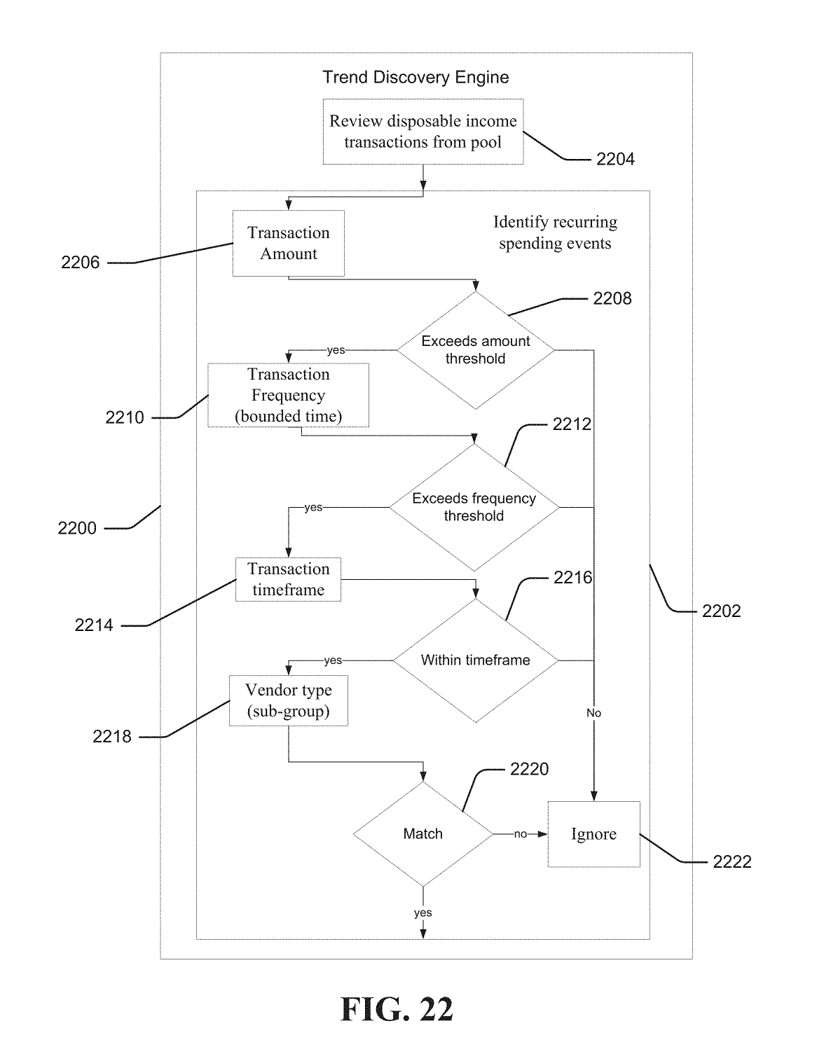

This disclosure also provides a system and method directed to allowing a user to visualize immediate financial decisions in terms of his or her long-term repercussions and to further identify habitual discretionary spending and re-allocate the funds that would be used for such habitual discretionary spending to financial instruments designed to grow long-term wealth. The systems and methods collect transaction information from an individual's bank accounts and parse the different kinds of information related to the transactions (i.e. type of vendor, amount of transaction, location of transaction, date of transaction, time of transaction, etc.). This information may then be categorized. The system and method may, for example, group transactions with similar types of vendors together (see FIG. 21). The system and method may also identify transactions with certain types or groups of vendors as necessary or discretionary expenditures. For example, purchases from gas stations may be viewed as necessary, while purchases from coffee vendors may be viewed as discretionary. The system and method may then identify recurring discretionary purchases (see FIGS. 20 and 22).

FIG. 20 illustrates an example process flow for determining whether a transaction is related to disposable income in accordance with this disclosure. As shown in FIG. 20, a method 2000 may include parsing 2002 transaction information and identifying 2004 vendor codes for the transactions. The method 2000 may also include matching 2006 the vendor codes to types of vendors and determining 2008 whether the types of vendors are associated with disposable income. Transactions associated with disposable income can be added 2010 to a disposable income transaction pool, while transactions not associated with disposable income may be flagged 2012 for determination whether the transactions relate to disposable or non-disposable income.

FIG. 21 illustrates an example process flow for determining the relatedness of vendors based on transaction information in accordance with this disclosure. As shown in FIG. 21, a method 2100 may include parsing 2102 transaction information and identifying 2104 vendor codes for the transactions. The method 2100 may also include trying to match 2106 the vendor codes to types of vendors. Transactions associated with specific vendor types can be added 2108 to a vendor type pool, while transactions not associated with specific vendor types may be flagged 2110 for determination of their vendor types.

FIG. 22 illustrates an example process flow for a financial trend discovery engine 2200 in accordance with this disclosure. Referring to FIG. 22, the trend discovery engine 2200 may include a recurrence module 2202 for identifying recurring spending events from a pool of disposable income transactions 2204. The recurrence module 2202 may review transaction amounts 2206 and compare 2208 the transaction amounts to an amount threshold. The recurrence module 2202 may also examine transaction frequencies 2210 for a bounded time period and determine 2212 whether a transaction frequency exceeds a frequency threshold. The recurrence module 2202 can further examine a transaction timeframe 2214 and determine 2216 whether the identified transactions occur within the timeframe. Recurrence of transactions may be set within a defined period of time or may be identified by regularity. In addition, the recurrence module 2202 can examine the vendor types 2218 for the transactions and determine 2220 whether the identified transactions tend to be made with the same vendor types. This could be indicative of recurring discretionary expenditures. If not, the transactions can be ignored 2222.

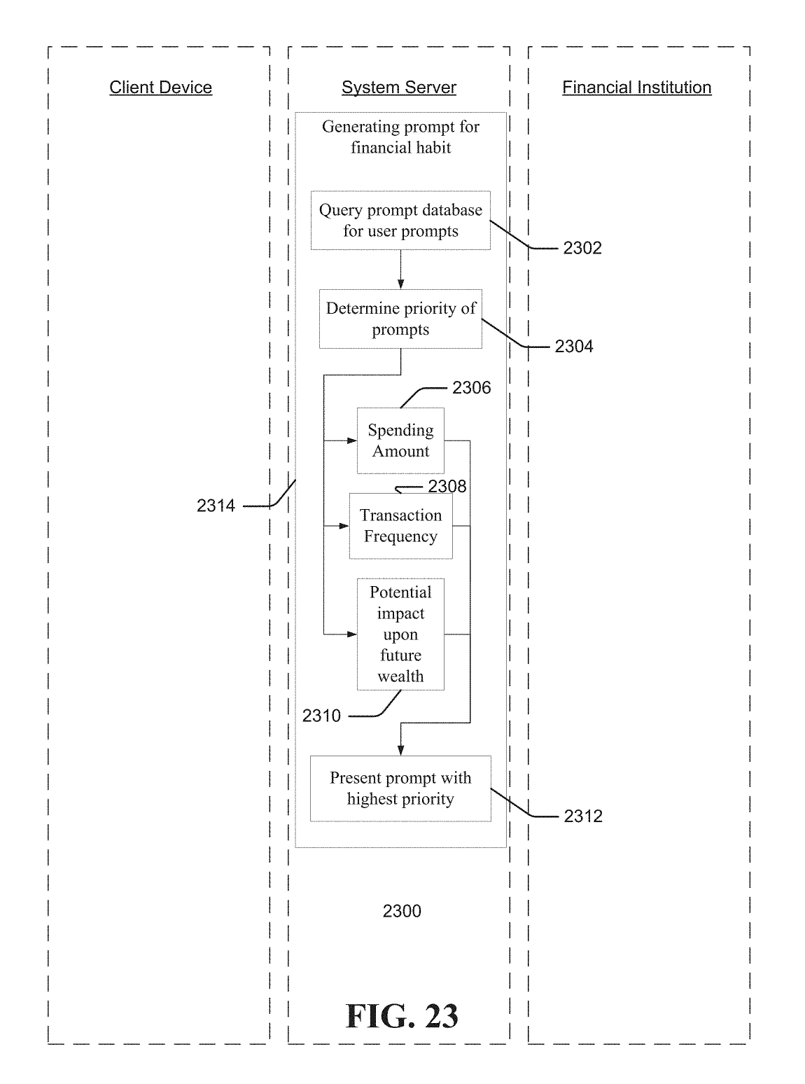

Once the engine 2200 has identified recurring discretionary expenditures, it may call up a tangible item associated with the type of vendor with which the individual is making such recurring discretionary transactions. Such a tangible item may have an associated value or may have a value related to the individual's transactions associated with it (i.e. a historic average of transactions or a percentage of a transaction). The engine 2200 may then present to the individual a visual prompt (see FIG. 23) at the individual's remote electronic device. The prompt could state that if the individual reduces the amount of, refrains from engaging in, or reduces the frequency of such recurring discretionary transactions, the immediate amount of money that he or she saves may correspond to a larger amount of money in the future. This may reflect the placement of such saved funds in a financial instrument designed to grow the individual's long-term wealth and may reflect things like compound interest over a set term.

It may be most effective for the system and method to focus on transactions with vendors that are associated with expenditures from an individual's disposable income. However, such may not be entirely necessary. The same systems and methods disclosed here could be used in relation to non-discretionary purchases such as rent.

FIG. 23 illustrates an example process flow for generating a user prompt directed at educating a user as to financial impact of his or her spending decisions and curbing negative spending habits in accordance with this disclosure. In particular, FIG. 23 illustrates a method 2300 for generating prompts for a financial habit of a user by a system including a system server. The method 2300 includes querying 2302 a prompt database for user prompts. The method 2300 also includes determining 2304 at least one priority of the prompts. The method 2300 further includes examining 2306 spending amounts, examining 2308 transaction frequencies, and examining 2310 potential impacts on future wealth. In addition, the method 2300 includes presenting 2312 a prompt with the highest priority. The following are example real-world implementations of the engine 2200 and the method 2300 described above.

Rent example: Beau is 25 and has provided profile information to the system indicating that he wants to retire at the age of 67. Beau rents an apartment for $1,400 a month and has monthly transactions corresponding thereto. The system is provided with information that indicates that the average rent in the same area or a related area is approximately $1,100 a month. The system may identify the recurring transactions related to Beau's payment of rent and identify that this amount may be reasonably reduced at Beau's discretion. The system could notify Beau that if he were to spend a year (12 months of rent) renting an apartment at $1,100, the savings would be $3,600 in that year. The system could further tell Beau that if he were to spend a year paying $1,100 a month in rent and placing the remaining $300 a month in a financial instrument configured to grow wealth at 10% annual interest over the next 42 years for his retirement, he would have a much larger amount of money at the time of his retirement.

Coffee shop example: Amy is 25 and consents to allow the system to access her financial accounts. Amy goes about her regular life, making transactions as she always had. Imagine that Amy likes coffee and tends to go to a local coffee shop and purchase a large coffee for $5. She does this five days a week, totaling $25 a week on coffee. Furthermore, she does this same thing every week. After a while, the system will be able to determine that Amy has a tendency to make recurring purchases of this type. The system can then send Amy a message stating that if she is able to curb this immediate habitual financial expenditure, in the long term she can reap rewards much greater than the caffeine buzz that she gets from the coffee in the morning. A few examples of such notifications may be:
‘Amy, did you know that if you skip your morning coffee just one day a week (four days a month) and place that $5 ($20 per month) into a retirement account with a 10% annual rate of return, that account could be worth 135,920 when you retire at 67?’
‘If you brew your own coffee in the morning it could increase your retirement stipend by $100 a month or $679,602?

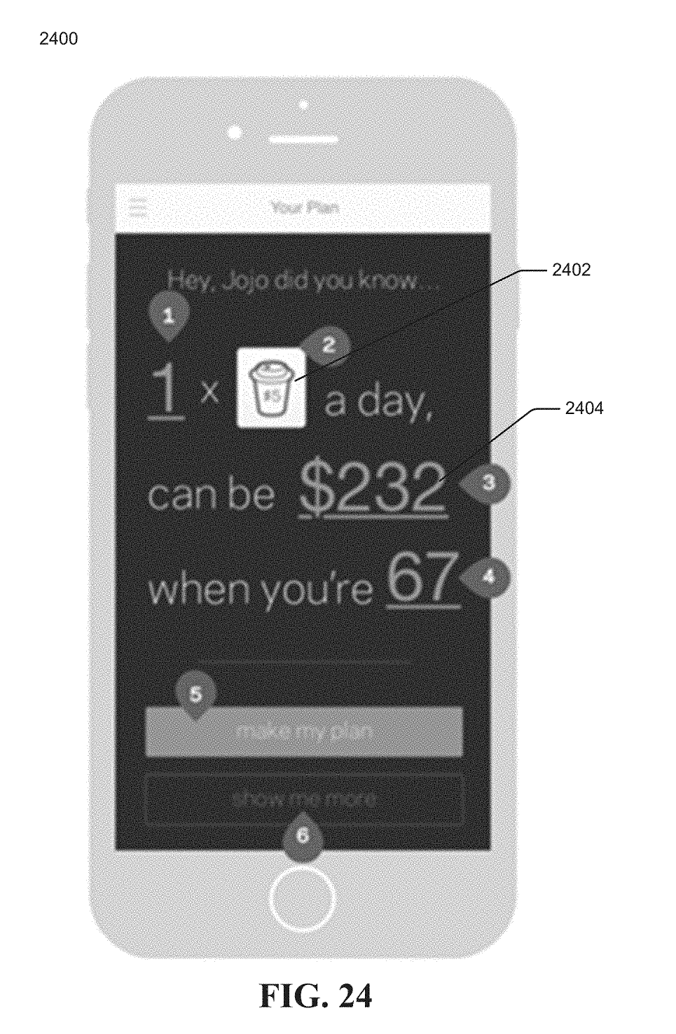

An example user prompt may be seen in FIG. 24. This concept may be expressed in any number of ways. Ideally, by identifying a long term value 2404 and associating it with the immediate discretionary purchase of a tangible item 2402, the system may be able to alter the instantaneous purchasing actions of an individual in a way that creates long-term benefits. The purchase amount in the prompt may be tied to the habitual purchase amount of the user or to a tangible item 2402 associated with the type of vendor at which the purchase is occurring. Specific examples of the types of prompts that could be generated include the following.

### Example 1

A user visits a particular coffee shop often. The system determines the average price of the user's visit and delivers a message informing the user that if his or her visits are limited to 4 days a week instead of 5 (items 1 and 2) and he or she contributes that money to a retirement account, this would translate to X amount of future value in the retirement account Y (item 4) years from now and Z (item 3) amount per month at retirement age.

### Example 2

A user currently eats out for lunch every day. The system determines the average price of the user's visit and pops up a message informing the user that if his or her visits are limited to 4 days a week instead of 5 (item 1 and 2) and he or she contributes that money to a retirement account, this would translate to X amount of future value in the retirement account Y (item 4) years from now and Z (item 3) amount per month at retirement age.

In some embodiments, the system and method may also record the user's choice to purchase or not purchase an item, as well as the date, time, location, and value of the purchase. This can help the system and method to more closely tailor the prompting to the user's activities.

In addition or in the alternative, in some embodiments, an automatic roll up may be associated with all transactions and may be linked to a tangible item associated with a discretionary purchase habit. A “roll up” may be defined as the amount of additional money needed to create a whole number in the type of currency in the transaction. For example, a purchase of $1.75 may be “rolled up” to $2.00 with the $0.25 being deposited in the account as a roll up. In some embodiments, set value contributions may exist at any given time and may be linked to a tangible item. Also, in some embodiments, the roll up nature of contributions may allow the rate of growth for the user's financial accounts to be very low. Further, in some embodiments, the disclosed method (and variations) may allow for these contributions to be initiated when certain categories of spending are triggered while creating an associated link in the user's mindset of what the additional charge may represent. In addition, in some embodiments, the contributions may be of higher value so the rate at which the user's financial accounts may grow may greatly increase.

In some embodiments, the system and method may implement prompts requesting the user to actively contribute to his or her long-term financial accounts. Such steps, which may include the system tracking the user's day-to-day activities based on credit and debit financial transactions and may make additional deductions from the user's linked accounts, may be funneled to the user's financial account (such as wealth growth, debt reduction, savings for life experience, etc.) based on the transactions category in which a payment may have been processed and upon confirmation from the user.

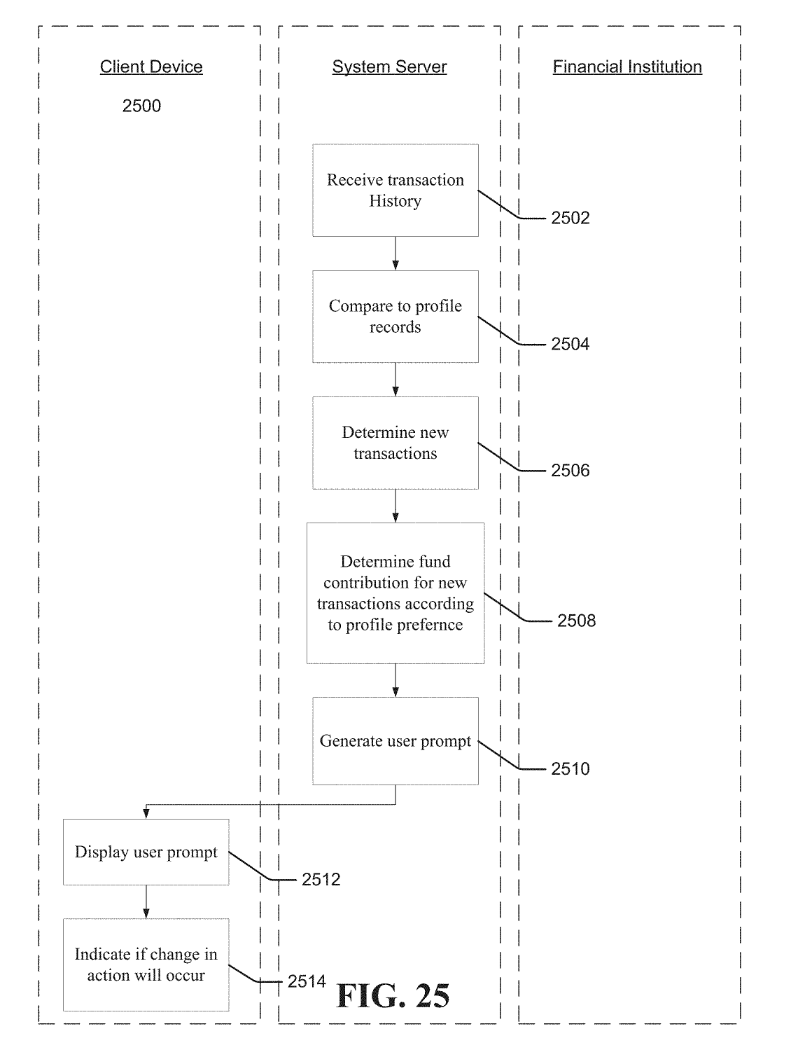

FIG. 25 illustrates an example process flow for generating a user prompt directed at providing a user an opportunity to change a spending decision and curbing a negative spending habit in relation to providing an opportunity to make a contribution of an amount determined in relation to a profile preference for the user in accordance with this disclosure. With reference to FIG. 25, in some embodiments, a corresponding system and method 2500 may attempt to elicit a contribution to a financial account such as, for example, a retirement account. The method 2500 may include receiving 2502 a user's transaction history and comparing 2504 the transaction history to profile records to identify 2506 new transactions. The transaction history could be received from any suitable accounts associated with a user, such as one or more financial accounts, software application accounts, or accounts associated with the user's electronic device. A fund contribution for the new transactions is determined 2508 according to the user's profile preference, and a user prompt is generated 2510 and displayed 2512. The user can then indicate 2514 whether to change the proposed fund contribution.

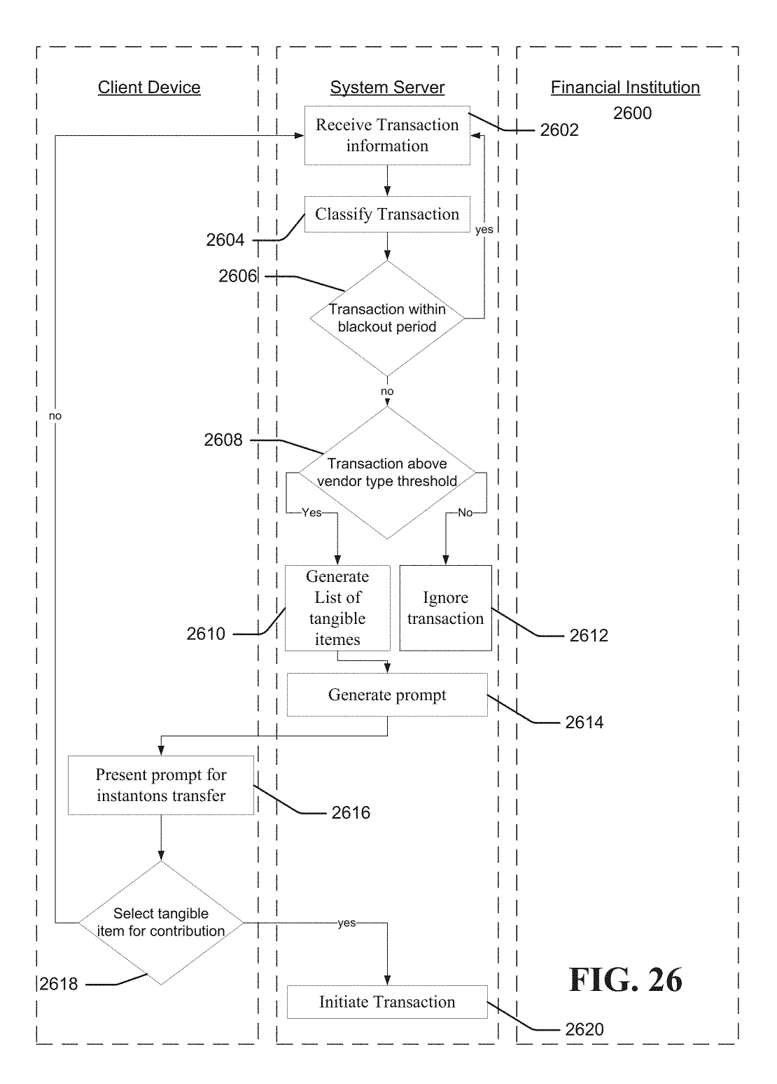

FIG. 26 illustrates an example process flow for providing a user the opportunity to make contributions to a financial account based on representative tangible items in accordance with this disclosure. With reference to FIG. 26, in some embodiments, a corresponding system and method 2600 may attempt to elicit a contribution to a financial account such as, for example, a retirement account. Such a method 2600 may include identifying a situation or circumstance when interaction with the account user may positively impact the value of the financial account by contribution to the same. In an example method, a situation when interaction with the account user may be initiated by an electronic system can be identified, such as a financial transaction. Example situations in financial transactions may include, for example, a debit or credit transaction, such as for the purchase of goods or services like a meal or coffee.

In this example, the method 2600 may include receiving 2602 transaction information and classifying 2604 a transaction. The method 2600 may also include determining whether the transaction is occurring in a blackout period when prompting for the classified transaction is not presented to preserve effectiveness of the prompting system by avoiding over-presenting prompts to the user. The method 2600 may further include determining 2608 whether a transaction is above a vendor type threshold. If so, a list of tangible items for a prompt is generated 2610. If not, the transaction is ignored 2612. The method 2600 also includes generating 2614 a prompt and presenting 2616 the prompt for instantaneous transfer. The method 2600 may further include selecting 2618 a tangible item for contribution and initiating 2620 a transaction.

The method 2600 therefore supports interacting with the account user at a moment when the user is determined to be performing impulse or discretionary spending for immediate gratification. In some embodiments, the communication with the account user may depend on or be responsive to specific information that is the subject of a behavioral analysis or predictive behavioral analysis. For example, if the user is using a credit or debit card at a bar, the user may be willing to allocate discretionary funds to a financial account if engaged by proposing the virtual transaction in terms of a tangible item having a specific value associated therewith, such as a certain drink. In some embodiments, the prompted transaction may be framed as a transaction involving a tangible item with associated monetary value. If the user authorizes the virtual transaction, a transaction can be executed with an amount corresponding to the monetary value associated with the selected tangible item, such as when the amount is transferred to a financial account.

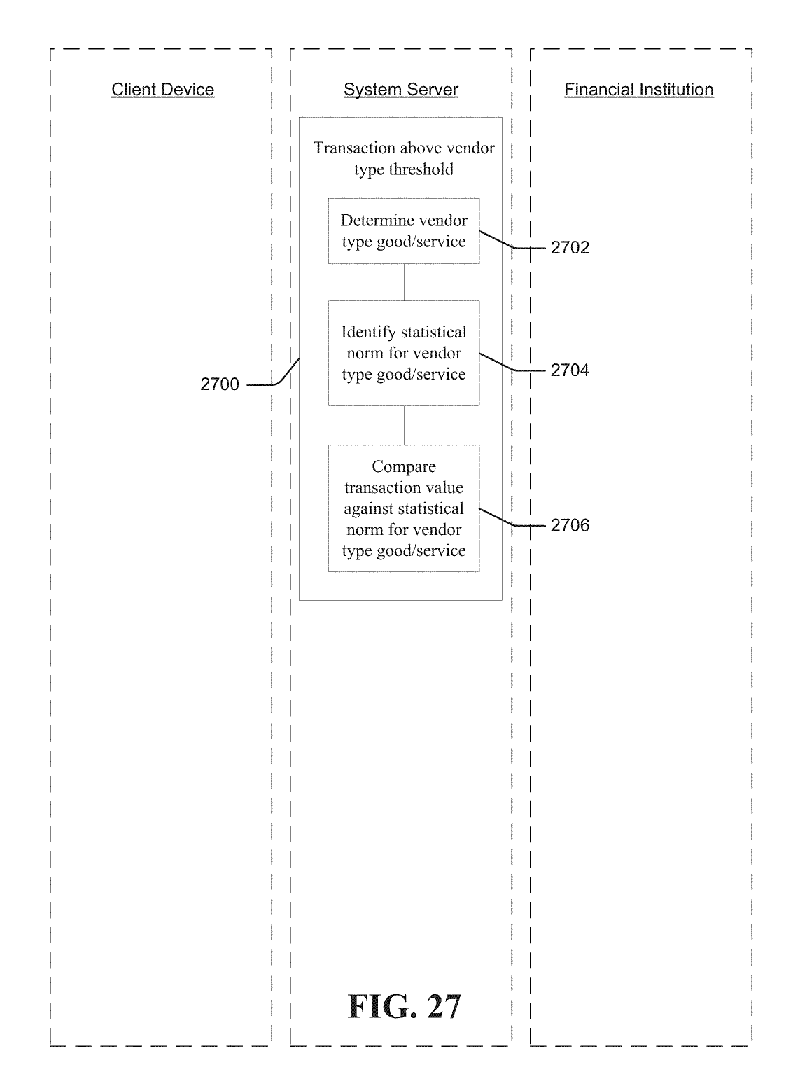

FIG. 27 illustrates an example process flow for determining whether a transaction is above a threshold value related to a vendor type in accordance with this disclosure. In some embodiments, such as in FIG. 27, a system and method 2700 may receive financial transaction information and categorize the transaction by vendor or type of vendor. In this manner, a system server may determine 2702 the type of vendor good or service and then identify 2704 a statistical norm as to the value of such a vendor good or service (with threshold amounts potentially predetermined or based off of historical transaction data). With such measures in place, the system may be able to compare 2706 the dollar value amount of a transaction against a threshold value for such a type of vendor transaction 2706.

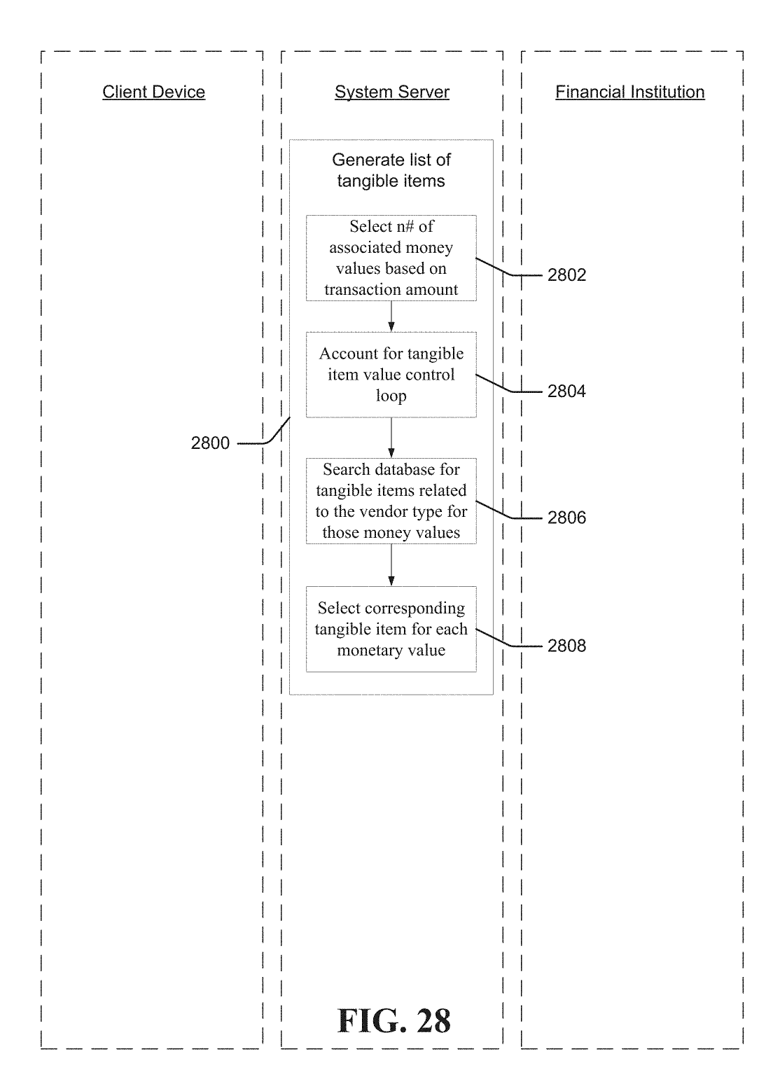

FIG. 28 illustrates an example process flow for generating a listing of tangible items and their associated values for presentation to a user in accordance with this disclosure. In particular, FIG. 28 provides another potential embodiment of a system and method 2800 that take into consideration if the amount of a recent transaction is greater than a threshold, in which case the system and method may identify one or more tangible items associated with that particular type of vendor or transaction along with corresponding monetary values for the tangible items. A number of monetary values for tangible items may be selected 2802 based off of a transaction amount, a threshold, or a tangible item itself. Through an account of a tangible item control 2804, the value of such tangible items can be identified through a database search 2806 of like items and vendor types associated therewith in terms of monetary values thereof. Through either or all such comparisons, the corresponding tangible item sought may then be selected 2808 in terms of monetary values in relation to the subject transaction.

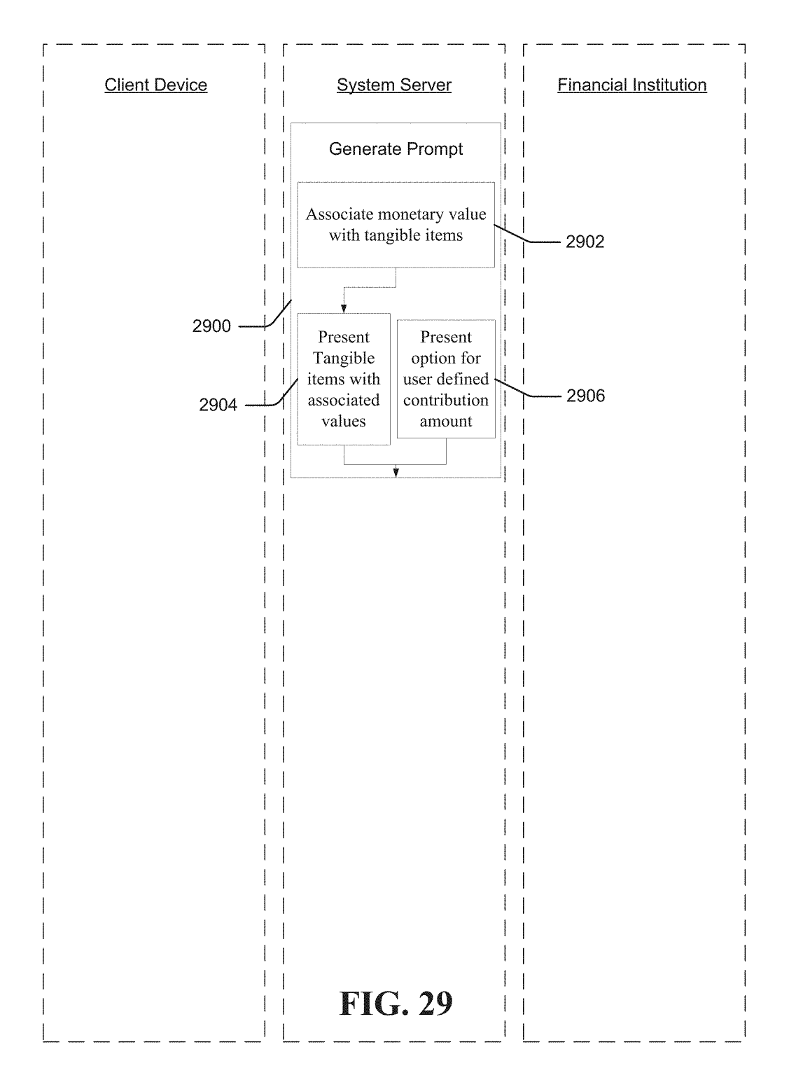

FIG. 29 illustrates an example process flow for generating a user prompt requesting contribution to a financial account based on tangible items in accordance with this disclosure. In FIG. 29, a potential embodiment of a system and method 2900 may generate and display a prompt at an individual's remote electronic device. The method 2900 associates 2902 one or more tangible items and their associated monetary values. A prompt is generated that presents 2904 the tangible items and their associated monetary values along with an option 2906 asking the individual if he or she would like to contribute one of the tangible items to a retirement account. If the individual selects the option to contribute, the system will transfer an amount corresponding to the monetary value of the tangible item from the individual's short-term account to the individual's long-term account or to another account designed to grow the user's wealth (i.e. paying off debt). A field for a user-defined contribution value may optionally be provided along with the contribution amounts attached to tangible items.

In some embodiments, virtual items may be visualized to give the user a mental representation of a tangible item and its associated cost. In some embodiments, these additional funds (withdrawals) may be created in parallel to a user's financial transaction. The following are examples of this functionality.

### Example 3

While at a restaurant, a credit or debit card transaction by a user triggers the system to be aware that the user has just made a purchase at a restaurant. A popup will appear that asks the user something like the following: ‘Would you like to add a dessert to your retirement account?’ (or generic financial account). The choices, such as ‘mint’ (1), ‘cookie’ (2), ‘cupcake’ (4), ‘other amount’ etc. will be tied to a momentary value, and this parallel charge will be processed to the debit card or withdrawal from a financial account (which represent savings, retirement, or debt reduction).

### Example 4

While at a bar, a credit or debit card transaction by a user triggers the system to be aware that the user is at a bar. A popup will appear that asks the user something like the following: ‘Would you like to add a beverage to your retirement account?’ (or generic financial account). The choices, such as ‘bottle of soda’, ‘glass of wine’, ‘glass of champagne’, ‘other amount’ etc. will be tied to a momentary value and this parallel charge will be processed to the debit card or withdrawal from a financial account (which represent savings, retirement, or debt reduction).

This system and method allow for immediate prompting of users to contribute to their long-term wealth development responsive to triggers that are likely to evidence an environment in which the users will be more willing to make such a contribution. In some embodiments, the elements causing the triggering of the prompts and associated tangible items may utilize behavioral analysis to determine when a user may be more likely to make a contribution. Also, in some embodiments, the system and method may request a user to save more money and make a targeted suggestion of a virtual tangible item that may be applicable to a user's spending habits. Further, in some embodiments, these small changes a user may make in his or her daily spending once redirected to a financial plan may make major changes for his or her future.

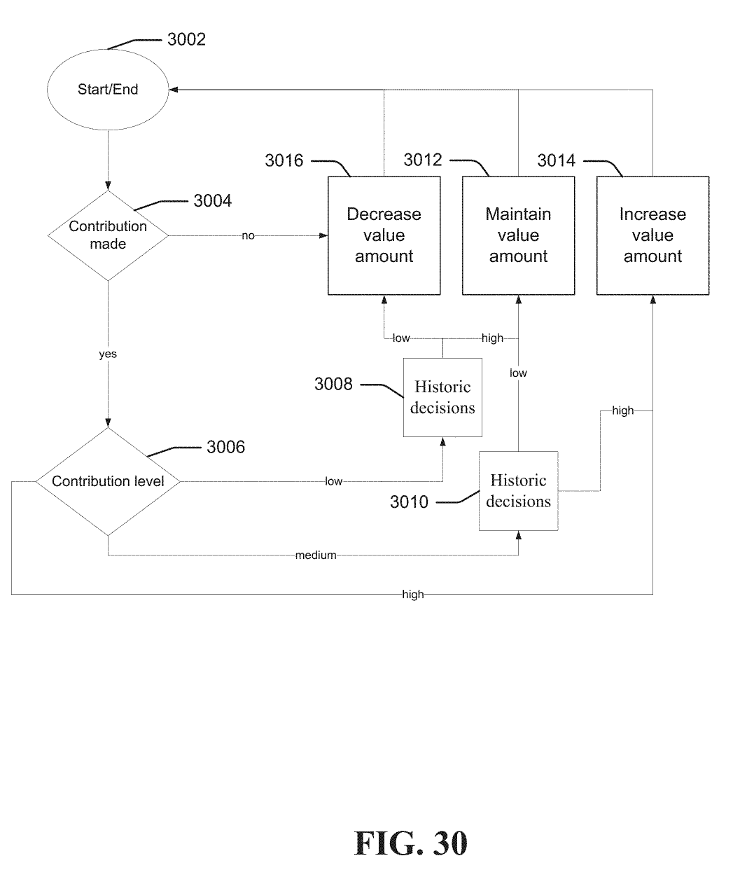

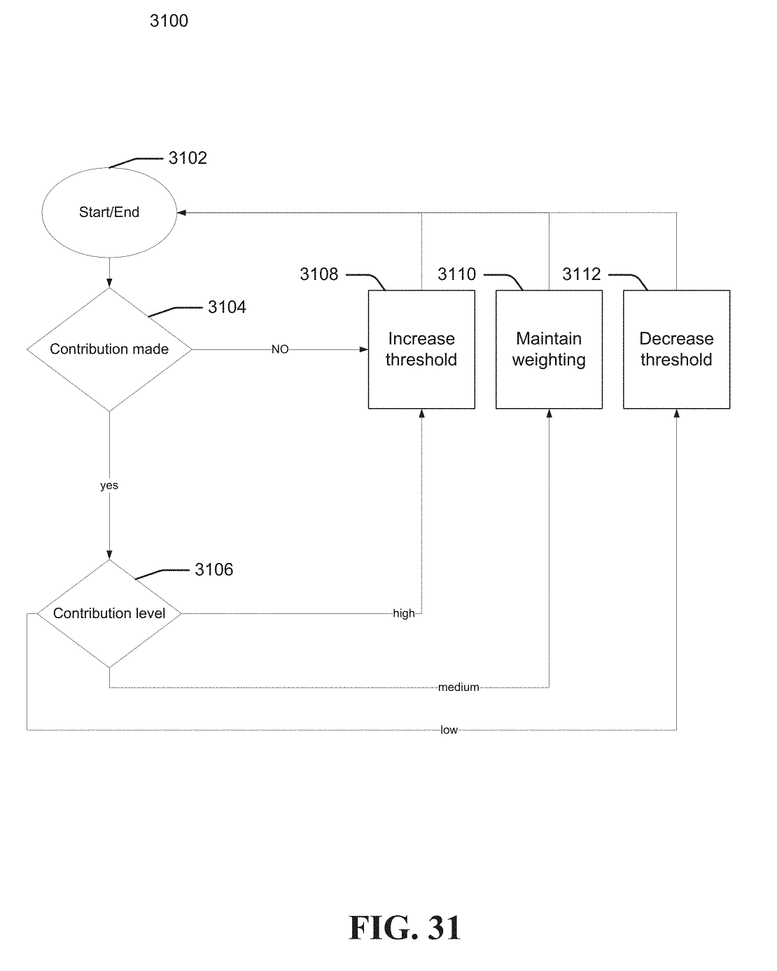

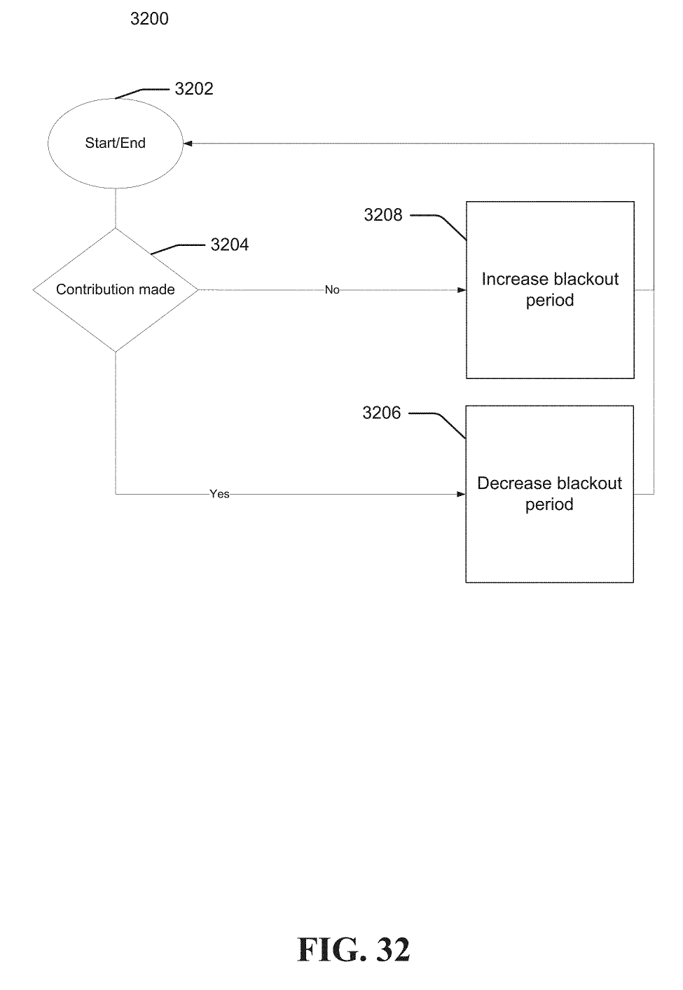

The systems and methods discussed above may use control loops with user feedback (such as through purchases or lack thereof or through user responses) to manage increment contribution values (see FIG. 30), update thresholds (see FIG. 31), and manage prompt timeframes (see FIG. 32), all in a non-limiting fashion as other variables may be utilized, so as to find an equilibrium in which the system maximizes user response while not annoying the user with excessive prompts. For example, FIG. 30 illustrates an example control loop 3000 for updating values associated with tangible items in accordance with this disclosure. As shown in FIG. 30, after the loop starts 3002, a decision 3004 is made whether to make a contribution. If so, a decision 3006 is made whether the contribution with be of a certain level. If a low level is selected, the system considers 3008 historical decisions of the same type and determines if such a contribution should remain low (leading to a decrease 3016 in contribution as compared with a prior contribution) or if such a contribution should remain high (leading to maintaining 3012 the same contribution as compared with a prior contribution). If a medium level is selected, the system considers 3010 historical decisions of the same type and determines if such a contribution should be maintained 3012 as compared with a prior contribution 3012 or if such a contribution should remain high (leading to an increase 3014 in contribution as compared with a prior contribution). If a high level is selected, this leads to an increase 3014 in contribution as compared with a prior contribution. The loop then proceeds to the end, which is the same step as the starting point 3002.

In FIG. 31, after a control loop 3100 starts 3102, a decision 3104 is made whether to make a contribution. If so, a decision 3106 is made if such a contribution will be of a certain level. If a low level is selected, the system decreases 3112 a threshold amount involved. If a medium level is selected, the system maintains 3110 the same threshold amount involved. If a high level is selected, the system increases 3108 the threshold amount involved. The loop then proceeds to the end, which is the same step as the starting point 3102.

In FIG. 32, the ability to set a timeframe for contribution prompts may be undertaken. After a control loop 3200 starts 3202, a decision 3204 is made whether to make a contribution. If the decision is to not contribute, the timeframe increases 3208 in relation to a contribution blackout. Conversely, if the decision is to contribute, the timeframe of the contribution blackout is decreased 3206. If a user always selects a tangible item corresponding to a minimum contribution value or does not contribute, the system and method may reduce the relative amounts of the tangible items the next time the prompt is triggered. These control loops may be applied to the systems and methods involving the display of information to a user to curb his or her negative financial habits and/or to the systems and methods requesting the user actively make a contribution to an account as applicable.

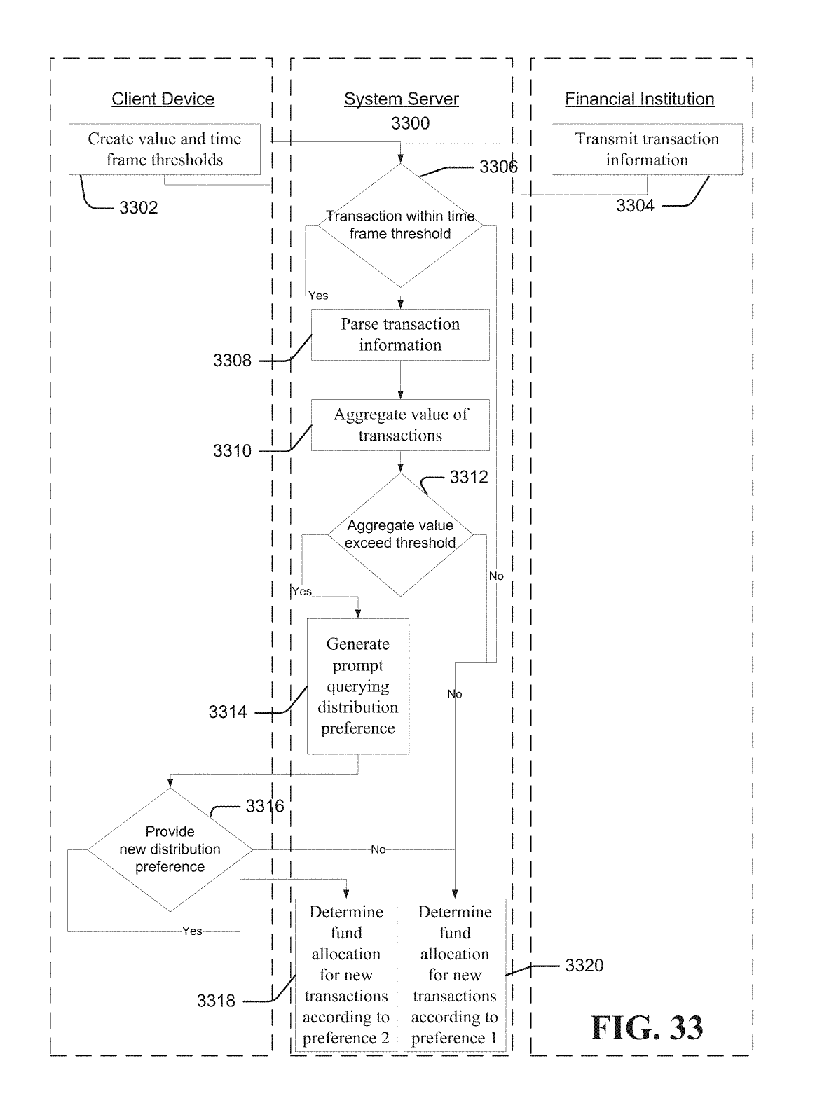

FIGS. 33 through 36 illustrate example process flows for determining fund allocation preferences for transaction values in accordance with this disclosure. More specifically, illustrated in FIGS. 33 through 36 are embodiments of systems and methods for monitoring and allocating user income according to preferences. It will be understood that the methods may be performed by operation of any suitable system having an arrangement or configuration operable to perform the methods as disclosed here.

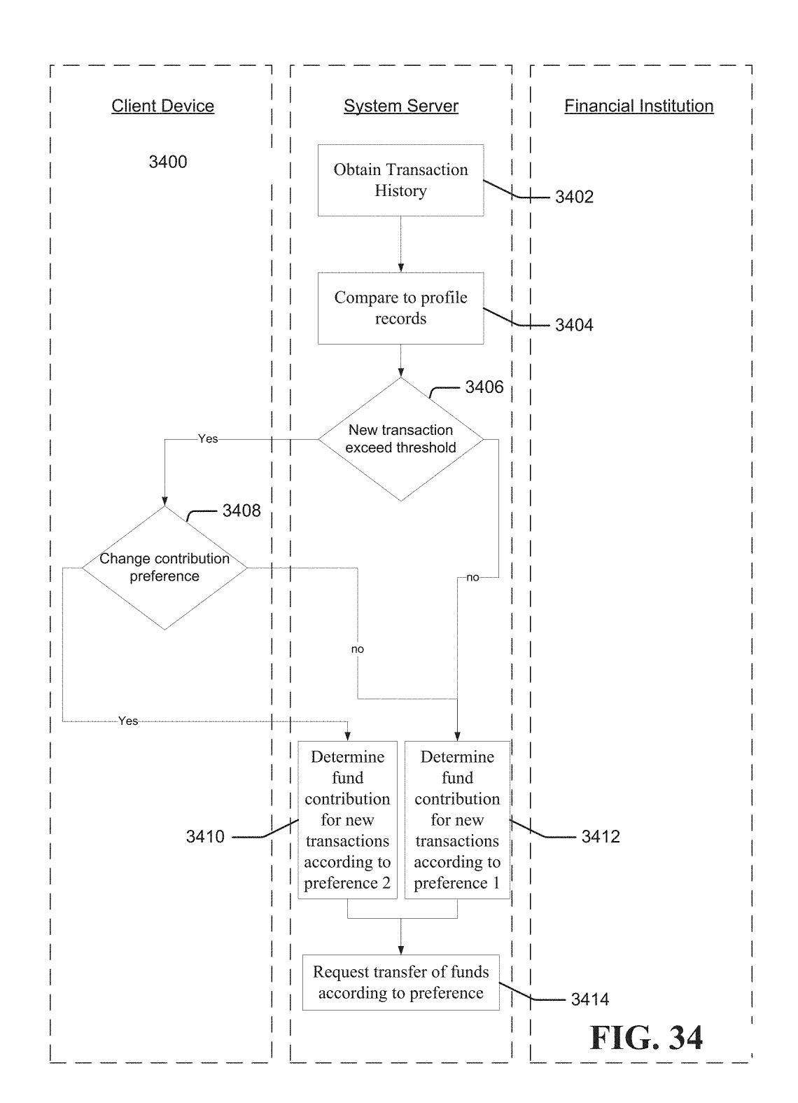

Referring to FIGS. 33 and 34, embodiments of systems and methods 3300 and 3400 may require input of user information, such as user financial account information, deposit value thresholds per time period, and distribution/allocation weighting preferences. The systems and methods may use the financial account information provided by a user to get information associated with user transactions, and in this case specifically information associated with deposits into a user's account.

In some embodiments, user information may specify instructions for distribution/allocation of deposited user funds according to a first weighting preference up until the deposit threshold value per unit time has been reached. At that time, the system and method may query the user if he or she would like to change the distribution/allocation weighting preference for any further funds deposited within the unit time.

In some embodiments, a user may be requested to specify a second preference to which the system may change at a given point or responsive to user acceptance. Preferences may be established through the use of the weighting tool system and method described here.

As shown in FIG. 33, a user may set 3302 a first distribution/allocation preference to be 100% towards his or her checking account, with a deposit threshold value per time period to be $200 per day. In this scenario, the system would monitor 3306 deposits within the one day time period and allocate/distribute 100% of the funds deposited into the checking account (through parsing 3308 of the transactions involved) if made within the set time period until the system determines 3312 that the new deposit will cause the aggregated 3310 total of the funds deposited that day to exceed the $200/day threshold. At that point, the system will send 3314 a prompt to the user to change his or her distribution/allocation preference (possibly suggesting increasing the distribution to long-term accounts). If the user changes 3316 the distribution/allocation preference, such as from 100% to checking to 50% to checking and 50% to savings, the system will distribute/allocate 3318 further deposits received within the time period according to the new distribution/allocation preference. If the user does not change the distribution/allocation preference, further deposits will be distributed/allocated 3320 according to the original preference. The system will reset the aggregate deposit total at the expiration of the indicated time period. The transaction information regarding such an issue will also be transferred 3304 by the financial institution to the system. Alternatively, in the event that transactions within a given time frame do not cause the aggregate amount to exceed the threshold, the system may continue requesting funds in accordance with the original distribution preference.

In some embodiments, as in FIG. 34, the determination of a time frame may include querying two or more transactions and determining receipt of funds within a specific elapsed period of time. For example, a system may determine the total amount of funds received by the user within an hourly period, within a daily period, within a weekly period, within a tax period, etc. Persons of ordinary skill in the art will understand that system architectures may be configured in a number of manners to determine a total funds received value, dependent upon specific objectives, without departing from the scope of this disclosure. As shown in FIG. 34, a transaction history is obtained 3402 and compared to profile records 3404 to determine 3406 whether new transactions exceed a threshold. The time periods in which transactional amounts may be aggregated to be compared against a threshold may be user defined or may be determined by the system through statistical modeling based on the user's previous transaction history. If the transaction amount exceeds the established threshold, the user has the option to change 3408 his or her contribution preference. If he or she decides not to change the contribution preference, further contributions are made 3412 in relation to such a preference. Alternatively, if he or she decides to change the contribution preference, further contributions are made 3410 in relation to a different preference. At that point, contributions/transactions are undertaken 3414 in relation to whichever preference has been selected.

In some embodiments, the methods and systems described here may be integrated into an application from a software provider (such as a ride-sharing application since it would have contractors whose income conforms to a variable wage model). If so integrated, the systems and methods may vary depending on the amount and type of information provided to the systems and methods by the associated application. In some embodiments, it may be the associated application or the user device that may supply the system with information, including transaction information, rather than or in addition to a financial institution.

In some embodiments, the systems and methods may be fully integrated into an associated application. Therefore, the structures for operation of the systems and methods may be built into the application software and infrastructure. If this is the case, the application may not need to provide much information to the system server since the data processing may be performed locally within the application rather than remotely (effectively having the application function as the system server). Furthermore, since the systems and methods are integrated directly into the associated application, they may have access to increased information, such as income rate multipliers and work hours associated with their users. This information may be able to assist the systems and methods in refining their decisions related to the receipt and transfer of funds. In such a scenario, the system server may only be receiving transfers of funds from the associated application.

In some embodiments, the systems and methods may be partially integrated into the associated application. In this scenario, a software application may provide the systems and methods with information related to each of the user transactions within the application, while a financial institution may provide information related to the user's financial accounts, including the deposit of the aggregated total value of the user transactions within the user's pay period. In such embodiments, the systems and methods may use the user's financial accounts information to inform and modify the system's reaction to the transaction information provided by the application. For example, if the user has a low balance in his or her financial accounts but the transaction information provided by the application indicates that the user is receiving a relatively large amount of funds, the systems and methods may determine that the user may be either cash rich or may be engaging in significant amounts of discretionary spending. Responsive to this determination, the systems and methods may either prompt the user to contribute to the financial accounts prior to the aggregate value of the user's transactions exceeding the set threshold for a given timeframe or may reduce the set threshold. By prompting the user for contributions to the user's financial accounts earlier, the systems and methods may be able to help reallocate the user's wealth from cash to banked funds or to curb the user's discretionary spending.

In some embodiments, the systems and methods may be minimally integrated with the associated application. In such cases, the application may provide the system server with quantities of transactions but not value amounts associated therewith. In such cases, the system server may receive transaction information including value amounts of deposits associated with the application transactions (within the same time frame, etc.) from a financial institution. The systems and methods may then perform statistical analysis on the information gained from both the application and the financial institution to determine correlations between the application transactions and the likely value associated therewith. These correlations may take into account any of a plurality of variables that may cause the value of the transactions to change (e.g. peak hours, rate multipliers, slow periods, etc.). Once a statistical model has been created, the systems and methods may be able to predict when there is a high likelihood of the user receiving higher than normal income and may provide them with prompts, including prompts to make a deposit, responsive thereto.

In some embodiments, the systems and methods may not be provided with any information from the application. In such embodiments, the system server may query the user's device to receive information related to the un-associated application. Such information may include, for example, the application's run-time. The application information may be compared against other generally known information (e.g. time of the day, day of the week, date, etc.), as well as transaction information from the user's associated financial institution (e.g. deposit amounts and timeframes) to determine a statistical income value weighting model through the use of statistical analysis. Once a statistical model has been created, the systems and methods may be able to predict when there is a high likelihood of the user receiving higher than normal income and may provide them with prompts, including prompts to make a deposit, responsive thereto.

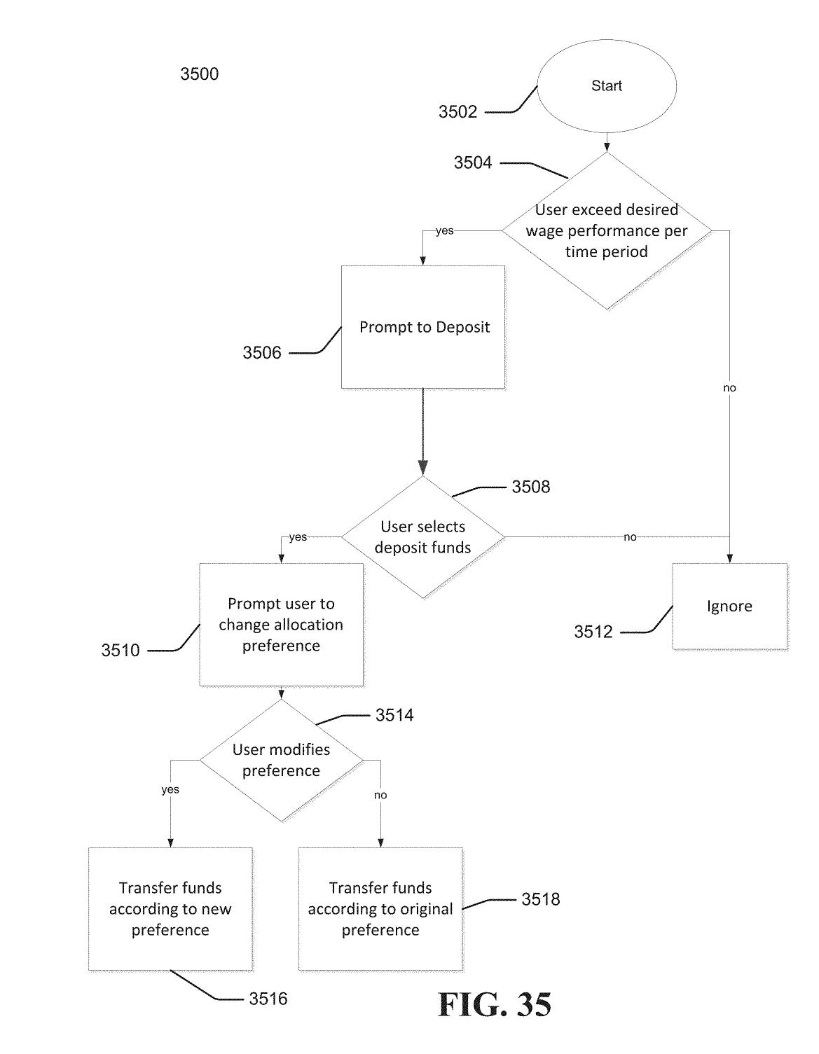

FIG. 35 illustrates an example process flow for determining fund allocation preferences for transaction values exceeding thresholds when account information is not provided in accordance with this disclosure. Referring to FIG. 35, in some embodiments where deposits into the user's financial account cannot be monitored (cash based or non-reporting income), a system and method 3500 may be provided to a user to make contributions to a financial account based on the user's unique goals if the user determines that his or her daily wage performance may have exceeded his or her goals for a specific day. In such embodiments, the system and method may be simplified from that described above by removing the portion of the system and method that receive transaction information from the user's account. Instead, the method may begin 3502 and prompt 3504 a user to identify if his or her desired wage performance was exceeded for that time period. If the user indicates that the desired wage performance was not met, the system takes no action 3512. If the user indicates that the desired wage performance was exceeded in the time period, the system may prompt 3506 the user to deposit any funds in excess of the desired wage performance. If the user initiates 3508 a deposit, the user is prompted 3510 for any changes in an allocation preference. If the user modifies 3514 the allocation preference, the funds are transferred 3516 according to the new preference. Otherwise, the funds are transferred 3518 according to the original preference. The distribution preference of the user may be modified and determined by the user at the time of the deposit, such as through use of the weighting tool described above. If the user does not initiate a deposit, nothing happens 3512. The method 3500 can be repeated once a time period expires.

In some embodiments, the systems and methods may be implemented in operations specializing in employees who earn a variable income or ‘tip’ based upon services rendered. Also, in some embodiments, the operations may either track the user's day-to-day wage performance based upon expected returns or may prompt the user either during or at the end of his or her shift if his or her wages have exceeded his or her expectation. If this determination from the user is positive that the user may be exceeding his or her daily expectations, a portion of these earnings may be funneled into the user's financial accounts.

The following examples are based in finance. However, the systems and methods should not be limited thereto and should be understood to be applicable to suitable scenarios across any industry.

An integrated software example partnering with service providers: While driving a taxi, after a set number of rides from the day, the system has determined that wage performance has exceeded an average expectation. A feature will appear that prompts the user if he or she would like to apply the next ride's proceeds to his or her financial accounts. Once the next ride is complete, the associated profit from that specific ride will flagged for transfer into the user's financial accounts. This transfer can be selected within the preferences to be instant or scheduled on the same day the user gets paid for services rendered. Once the money has been transferred into the financial accounts based on user predefined preferences, these funds may be filtered towards savings, retirement, or debt reduction.

A standalone example: While providing a service (bartending, waiting tables, delivery food, etc.), after the end of a shift, a feature will appear that prompts the user if he or she received tips over what he or she expected for the shift. The software may not ask the user for a valuation of these ‘tips’. If the ‘tips’ are over the user's expected returns, the user will be prompted to apply a set value or to funnel a portion of his or her base salary (up to 100%) into his or her retirement account. This transfer can be selected within the preferences to be instant or scheduled on the same day the user gets paid for services rendered. Once the money has been transferred into the financial accounts based on user predefined preferences, these funds may be filtered towards savings, retirement, or debt reduction.

In some embodiments, the systems and methods may cater to users in the service industry in which wage performance may be variable. By helping a user ride the momentum of a higher performing shift, a portion of his or her payroll may be rerouted to the user's financial accounts. These small changes to a user's financial accounts may make major changes for his or her future.

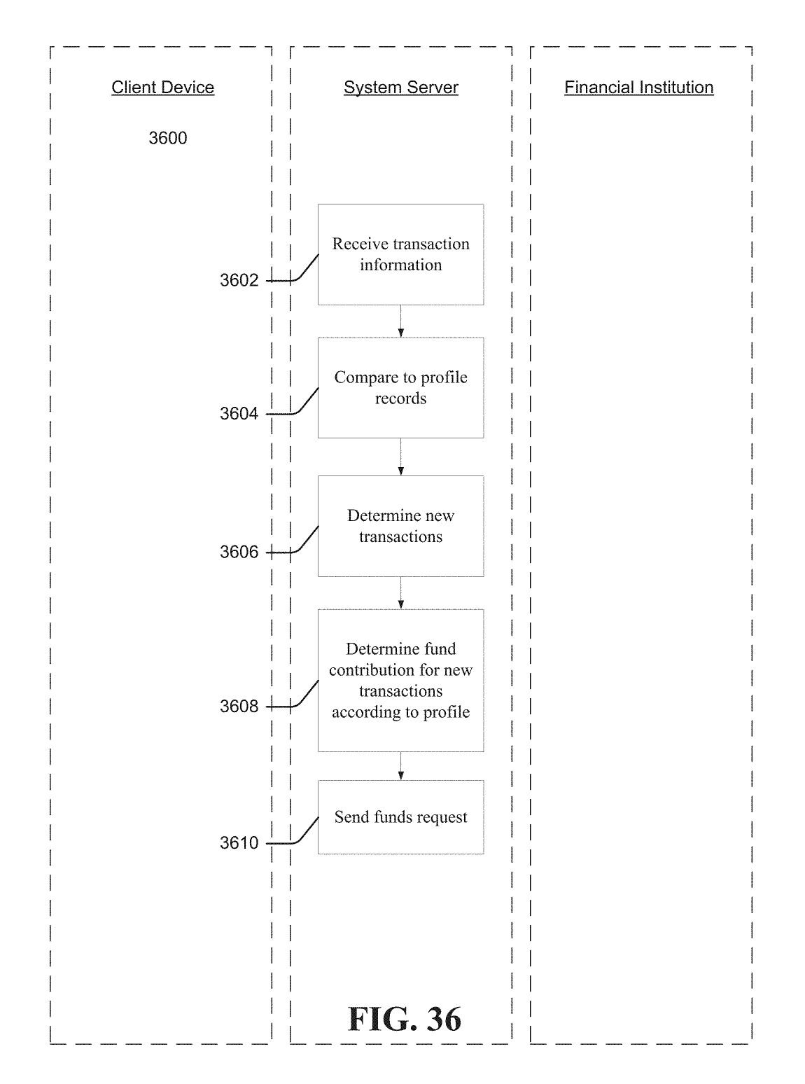

FIG. 36 illustrates an example process flow for determining fund allocation preferences for transaction values in relation to a profile in accordance with this disclosure. With reference to FIG. 36, this disclosure may further provide a system and method 3600 for identifying changes in financial circumstances of a user and requesting re-prioritization of fund distributions related thereto. In some embodiments, the system and method 3600 may optimize positive or negative financial events in a user's life when those events occur. Also, in some embodiments, the system may interact with a user to assist the user in order to execute educated financial decisions.

As shown in FIG. 36, the system may directly ask a user or automatically probe a user's financial accounts to receive 3602 transaction information. The transaction information is compared 3604 to identify 3606 new transactions, such as anomalous deposits or other transactions that may identify when a change in financial events in the user's life could have occurred (such as bonuses, overtime, tips, raises, loss of job, demotion, garnishment of wages, etc.). Once the system determines that there has been a change as compared to the user's historic data, the system may request 3608 a modification of the distribution/allocation preference to account for the change in financial circumstances and request 3610 a funds transfer as a result.

Methods employed by the system may be tailored to each unique user's income and financial goals in order to make educated suggestions to the user. In some embodiments, systems and methods 3700 and 3800 may support two ways of gathering financial history from a user. In a non-integrated version, a method 3700 may be used for users who have not linked their financial accounts within the application. In this situation, a user may initiate a process when a change in financial events within his or her life has occurred. In such a version, the system receives 3702 the user's transaction history, compares 3704 it with the user's profile, and automatically determines 3706 the extent of any new transactions as a result. In response, the system determines 3708 fund contributions (such as in relation to checking, savings, retirement, etc., accounts for a user) in relation to such new transactions and sends 3710 a request to the user for approval of such changes. The user may then provide 3712 his or her approval, which results in a transfer 3714 by the system of funds as approved. If the user refuses such changes, the process returns to the received transaction history step 3702 for a new process to begin.

In an integrated version, the method 3800 may allow a user to link financial accounts within the system. Once financial accounts are integrated from the user into the system (and transmitted 3802 deposit information from the financial institution to the system), the system may begin executing 3804 system processes to trend nominal deposits, regular transactions, and user cash flow (through comparisons). A deposit 3806 may then be made with the determination if such is consistent with historic models (such as an automatic deposit is made that differs from the previous trend). If the deposit meets a trend, the deposit is considered 3808 the same as in the historical deposit pool, and the next deposit is considered in step 3804. When an anomalous deposit or a deviation occurs from the nominal trend, a system process 3810 may be triggered, and the system develops 3812 an anomalous trend model, compares 3816 such a model with the historic model, and measures 3818 the deviation between the two. If the deviation is considered significant, the system prompts 3820 a suggestion for the user to change his or her deposit allocation. The user may then accept 3822 such a change, which activates a deposit allocation preference modification 3826. If the deviation is not significant or if the user elects not to accept a change from the system suggestion, the system ignores 3822 the anomalous deposit, and no change is undertaken.

In both methods 3700 and 3800, after the system has identified a change in financial events, a directed message may be generated and transmitted to the user. The directed message may contain a prompting that may enable the user to modify the distribution/allocation of future deposits responsive to the changed circumstances.

In some embodiments, the systems and methods may enable users to make educated financial choices when positive events in their life occur. These financial choices may allow the users to stay on track for their financial goals. In many instances, when a user receives an increase in monetary funds, his or her financial savings goals are typically not proportional to the amount that he or she received. Similarly, in instances when the user receives a decrease in funds, he or she may not alter or reduce his or her spending habits consistent therewith. These methods and systems may allow users to continue to be financially smart with their funds and may continue to work towards their own financial goals when changes in their receipt of funds occur.

It will be understood that the systems and methods described here may include at least one computing system in communication with a communication network, which may allow for communication with at least one remote computing device such as a server. The systems and methods described here may also include one or more wireless computing devices, such as smartphones or tablets, each having a user interface and a display. In some embodiments, the user interface and display may form a touchscreen interface.

Although example systems, devices, and methods have been described above and shown in the figures, various changes may be made to the systems, devices, and methods. For example, various components in each system or device could be combined, further subdivided, rearranged, or omitted and additional components could be added according to particular needs. Computing devices and wireless devices come in a wide variety of configurations, and the figures do not limit this disclosure to any particular computing device or wireless device. One skilled in the art, using this disclosure, could develop additional hardware, software, and/or firmware to practice the disclosed subject matter, and each is intended to be included here. Also, while various figures show sequences of process or method steps, various steps in these figures could overlap, occur in parallel, occur in a different order, or occur any number of times. In addition to the above-described embodiments, those skilled in the art will appreciate that this disclosure has application in a variety of arts and situations and that this disclosure is intended to include the same.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as ROM, RAM, a hard disk drive, a CD, a DVD, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The singular forms “a,” “an,” and “the” are intended to include the plural forms as well, unless the context clearly indicates otherwise. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. §112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. §112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method for prompting a user, the method comprising:
determining a threshold value for a defined time period;
determining if the user has received funds in excess of the threshold value within the time period; and
in response to determining that the user has received the funds in excess of the threshold value within the time period, prompting the user to deposit at least part of the funds in excess of the threshold value into an account.

2. The method of claim 1, further comprising:
receiving transaction information from the account or another account associated with the user;
wherein determining if the user has received the funds in excess of the threshold value within the time period comprises:
parsing transaction values and transaction times from the received transaction information;
identifying transactions occurring within the time period based on the transaction times;
aggregating the transaction values for each transaction within the time period; and
comparing the aggregated transaction values against the threshold value.

3. The method of claim 2, wherein the user is associated with at least one of: a financial account, a software application account, and an account associated with the user's electronic device.

4. The method of claim 1, further comprising:
receiving transaction information from the account or another account associated with the user;
wherein determining the threshold value comprises:
creating a statistical model of total transaction value for a time period analogous with the defined time period based on historical transaction information; and
selecting a value within norms of the statistical model as the threshold value.

5. The method of claim 1, wherein:
determining the threshold value comprises:
receiving the threshold value from the user; and
receiving a time period from the user; and
determining if the user has received the funds in excess of the threshold value within the time period comprises receiving user input indicating that the user believes the user has exceeded the threshold value within the time period.

6. The method of claim 1, further comprising:
based on a response to the prompting, causing an external system to deposit the at least part of the funds in excess of the threshold value into the account.

7. The method of claim 1, wherein:
the user is prompted to deposit the at least part of the funds in excess of the threshold value based on a first contribution preference; and
the method further comprises receiving a second contribution preference and prompting the user to deposit additional funds based on the second contribution preference.

8. An apparatus comprising:
at least one processor; and
at least one memory disposed in communication with the at least one processor and configured to provide a plurality of instructions stored in the at least one memory to the at least one processor, wherein the instructions when executed cause the at least one processor to:
determine a threshold value for a defined time period;
determine if the user has received funds in excess of the threshold value within the time period; and
in response to determining that the user has received the funds in excess of the threshold value within the time period, prompt the user to deposit at least part of the funds in excess of the threshold value into an account.

9. The apparatus of claim 8, wherein:
the instructions when executed further cause the at least one processor to receive transaction information from the account or another account associated with the user; and
the instructions that when executed cause the at least one processor to determine if the user has received the funds in excess of the threshold value within the time period comprise instructions that when executed cause the at least one processor to:
parse transaction values and transaction times from the received transaction information;
identify transactions occurring within the time period based on the transaction times;
aggregate the transaction values for each transaction within the time period; and
compare the aggregated transaction values against the threshold value.

10. The apparatus of claim 9, wherein the user is associated with at least one of: a financial account, a software application account, and an account associated with the user's electronic device.

11. The apparatus of claim 8, wherein:
the instructions when executed further cause the at least one processor to receive transaction information from the account or another account associated with the user; and
the instructions that when executed cause the at least one processor to determine the threshold value comprise instructions that when executed cause the at least one processor to:
create a statistical model of total transaction value for a time period analogous with the defined time period based on historical transaction information; and
select a value within norms of the statistical model as the threshold value.

12. The apparatus of claim 8, wherein:
the instructions that when executed cause the at least one processor to determine the threshold value comprise instructions that when executed cause the at least one processor to:
receive the threshold value from the user; and
receive a time period from the user; and
the instructions that when executed cause the at least one processor to determine if the user has received the funds in excess of the threshold value within the time period comprise instructions that when executed cause the at least one processor to receive user input indicating that the user believes the user has exceeded the threshold value within the time period.

13. The apparatus of claim 8, wherein the instructions when executed further cause the at least one processor, based on a response to the prompting, to cause an external system to deposit the at least part of the funds in excess of the threshold value into the account.

14. The apparatus of claim 8, wherein:
the instructions when executed cause the at least one processor to prompt the user to deposit the at least part of the funds in excess of the threshold value based on a first contribution preference; and
the instructions when executed further cause the at least one processor to receive a second contribution preference and prompt the user to deposit additional funds based on the second contribution preference.

15. A non-transitory computer readable storage medium containing instructions that, when executed by at least one processor, cause the at least one processor to:
determine a threshold value for a defined time period;
determine if the user has received funds in excess of the threshold value within the time period; and
in response to determining that the user has received the funds in excess of the threshold value within the time period, prompt the user to deposit at least part of the funds in excess of the threshold value into an account.

16. The non-transitory computer readable storage medium of claim 15, wherein:
the instructions when executed further cause the at least one processor to receive transaction information from the account or another account associated with the user; and
the instructions that when executed cause the at least one processor to determine if the user has received the funds in excess of the threshold value within the time period comprise instructions that when executed cause the at least one processor to:
parse transaction values and transaction times from the received transaction information;
identify transactions occurring within the time period based on the transaction times;
aggregate the transaction values for each transaction within the time period; and
compare the aggregated transaction values against the threshold value.

17. The non-transitory computer readable storage medium of claim 15, wherein:
the instructions when executed further cause the at least one processor to receive transaction information from the account or another account associated with the user; and
the instructions that when executed cause the at least one processor to determine the threshold value comprise instructions that when executed cause the at least one processor to:
create a statistical model of total transaction value for a time period analogous with the defined time period based on historical transaction information; and
select a value within norms of the statistical model as the threshold value.

18. The non-transitory computer readable storage medium of claim 15, wherein:
the instructions that when executed cause the at least one processor to determine the threshold value comprise instructions that when executed cause the at least one processor to:
receive the threshold value from the user; and
receive a time period from the user; and
the instructions that when executed cause the at least one processor to determine if the user has received the funds in excess of the threshold value within the time period comprise instructions that when executed cause the at least one processor to receive user input indicating that the user believes the user has exceeded the threshold value within the time period.

19. The non-transitory computer readable storage medium of claim 15, wherein the instructions when executed further cause the at least one processor, based on a response to the prompting, to cause an external system to deposit the at least part of the funds in excess of the threshold value into the account.

20. The non-transitory computer readable storage medium of claim 15, wherein:
the instructions when executed cause the at least one processor to prompt the user to deposit the at least part of the funds in excess of the threshold value based on a first contribution preference; and
the instructions when executed further cause the at least one processor to receive a second contribution preference and prompt the user to deposit additional funds based on the second contribution preference.
